(19) United States
(12) Patent Application Publication
(10) Pub. No.: US 2013/0105732 A1
(43) Pub. Date: May 2, 2013

(54) LIQUID CRYSTAL COMPOSITION, POLYMER/LIQUID CRYSTAL COMPOSITE, LIQUID CRYSTAL ELEMENT, AND LIQUID CRYSTAL DISPLAY DEVICE

(71) Applicant: Semiconductor Energy Laboratory Co., Ltd., Atsugi-shi (JP)

(72) Inventors: Daisuke KUBOTA, Isehara (JP); Takahiro YAMAMOTO, Tokyo (JP); Makoto IKENAGA, Atsugi (JP)

(73) Assignee: SEMICONDUCTOR ENERGY LABORATORY CO., LTD., Atsugi-shi (JP)

(21) Appl. No.: 13/658,205

(22) Filed: Oct. 23, 2012

(30) Foreign Application Priority Data
Oct. 31, 2011 (JP) 2011-238282

(51) Int. Cl. C09K 19/20; C09K 19/12; C09K 19/38; C09K 19/30

(52) U.S. Cl. 252/299.63; 252/299.64; 252/299.65; 252/299.66

(57) ABSTRACT

A liquid crystal composition with which generation of an alignment defect in a polymer/liquid crystal composite exhibiting a polymer-stabilized blue phase can be reduced is provided. The liquid crystal composition includes a liquid crystal material exhibiting a blue phase; and a liquid crystalline monomer. In the liquid crystalline monomer, the chain length (the sum of carbon atoms and oxygen atoms) of an oxyalkylene group represented as Y in the following general formula (G1) is n (2≦n≦11). The liquid crystalline monomer has a lower phase transition temperature from a nematic phase to an isotropic phase (T_{NI}) than liquid crystalline monomers including the oxyalkylene groups whose chain lengths are (n−1) and (n+1).

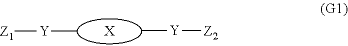

In (G1), X represents a mesogenic skeleton; Y represents an oxyalkylene group (including carbon and oxygen), and includes hydrogen or fluorine; and Z₁ and Z₂ individually represent an acryloyl group or a methacryloyl group.

### BACKGROUND OF THE INVENTION

1. Field of the Invention

The present invention relates to a liquid crystal composition that achieves a polymer-stabilized blue phase, a polymer/liquid crystal composite which is obtained by polymer stabilization of the liquid crystal composition, a liquid crystal element, and a liquid crystal display device.

2. Description of the Related Art

In recent years, flat panel displays have been put to practical use and have been substituted for conventional displays using cathode-ray tubes. The flat panel displays include liquid crystal display devices which have liquid crystal display elements, EL display devices which have electro-luminescent elements (EL elements), plasma displays, and the like, and they come into competition in the market. At present, liquid crystal display devices establish a position of superiority by overcoming disadvantages and suppressing production cost with the use of a variety of techniques.

The above liquid crystal display devices, however, are inferior to the other flat panel displays in a response speed of an element (a speed of switching the display). Various techniques for overcoming the disadvantage in a response speed have been proposed so far. A conventional liquid crystal element which employs a driving method of liquid crystal called a twisted nematic (TN) mode has a response speed of approximately 10 ms, whereas a liquid crystal element which employs an optical compensated bend (OCB) mode or a ferroelectric liquid crystal (FLC) mode has achieved an improved response speed of approximately 1 ms.

Another technique which attracts as much attention as these driving methods of liquid crystal applies a state called a blue phase to a liquid crystal display element (for example, see Patent Document 1). The blue phase is a liquid crystal phase which appears between a cholesteric phase and an isotropic phase, and has a characteristic of an extremely high response speed. With the use of this blue phase, the response speed of a liquid crystal display device can be 1 ms or shorter.

It has been reported that although a blue phase has a feature of a narrow temperature range of several Celsius degrees in which the alignment state can be maintained, the temperature range where a blue phase appears can be improved by using a polymer/liquid crystal composite that is obtained by the polymerization of a liquid crystal composition including a liquid crystal material exhibiting a blue phase and a polymerizable monomer (for example, see Patent Document 2).

### REFERENCE

### [Patent Documents]

[Patent Document 1] PCT International Publication No. WO2005/090520
[Patent Document 2] Japanese Published Patent Application No. 2003-327966

### SUMMARY OF THE INVENTION

However, it has been confirmed that, when a liquid crystal composition including a liquid crystal material exhibiting a blue phase and a polymerizable monomer is polymerized by polymer stabilization treatment in order to obtain a polymer/liquid crystal composite, the alignment state of the blue phase cannot be maintained in some cases. Generation of such an alignment defect causes a defect of a liquid crystal element utilizing a polymer-stabilized blue phase obtained from the polymer/liquid crystal composite or a defect of a display panel using the liquid crystal element such as a liquid crystal panel, which leads to a reduction in yield or the like.

In view of the above problem, one embodiment of the disclosed present invention provides a liquid crystal composition with which generation of an alignment defect in a polymer/liquid crystal composite exhibiting a polymer-stabilized blue phase can be reduced. Further, a liquid crystal element including a polymer/liquid crystal composite which is obtained by polymerization of the above liquid crystal composition and exhibits a polymer-stabilized blue phase is provided. Furthermore, a liquid crystal display device including a polymer/liquid crystal composite which is obtained by polymerization of the above liquid crystal composition and exhibits a polymer-stabilized blue phase is provided.

One embodiment of the present invention is a liquid crystal composition including at least a liquid crystal material exhibiting a blue phase; and a liquid crystalline monomer. In the liquid crystalline monomer, the chain length (the sum of carbon atoms and oxygen atoms) of an oxyalkylene group represented as Y in the following general formula (G1) is n (n is greater than or equal to 2 and less than or equal to 11). The liquid crystalline monomer has a lower phase transition temperature from a nematic phase to an isotropic phase (T_{NI}) than a liquid crystalline monomer including the oxyalkylene group whose chain length (the sum of carbon atoms and oxygen atoms) is (n−1) and a liquid crystalline monomer including the oxyalkylene group whose chain length (the sum of carbon atoms and oxygen atoms) is (n+1). Note that the liquid crystal composition may include a non-liquid-crystalline monomer and a polymerization initiator.

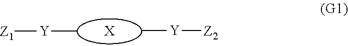

In the general formula (G1), X represents a mesogenic skeleton. Further, in the general formula (G1), Y represents an oxyalkylene group (including carbon and oxygen), and the chain length (the sum of carbon atoms and oxygen atoms) n of Y is greater than or equal to 2 and less than or equal to 11 that enables the liquid crystallinity to be maintained and does not decrease the compatibility between the liquid crystalline monomer and the liquid crystal material exhibiting a blue phase. Note that Y includes hydrogen or fluorine. Furthermore, in the general formula (G1), Z₁ and Z₂ individually represent an acryloyl group or a methacryloyl group.

Another embodiment of the present invention is a liquid crystal composition including at least a liquid crystal material exhibiting a blue phase; and a liquid crystalline monomer. In the liquid crystalline monomer, the chain length (the sum of carbon atoms and oxygen atoms) of an oxyalkylene group ((—O—(CH₂)ₘ—), m is an integer) in the following general formula (G1-1) is n (n=m+1, and n is greater than or equal to 2 and less than or equal to 11). The liquid crystalline monomer has a lower phase transition temperature from a nematic phase to an isotropic phase (T_{NI}) than a liquid crystalline monomer including the oxyalkylene group whose chain length (the sum of carbon atoms and oxygen atoms) is (n−1) and a liquid crystalline monomer including the oxyalkylene group whose chain length (the sum of carbon atoms and oxygen atoms) is (n+1). Note that the liquid crystal composition may include a non-liquid-crystalline monomer and a polymerization initiator.

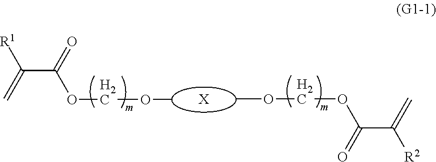

In the general formula (G1-1), X represents a mesogenic skeleton. Further, in the general formula (G1-1), m is greater than or equal to 1 and less than or equal to 10 that enables the liquid crystallinity to be maintained and does not decrease the compatibility between the liquid crystalline monomer and the liquid crystal material exhibiting a blue phase. Furthermore, in the general formula (G1-1), R¹ and R² individually represent hydrogen or a methyl group.

Note that in the above structure, X in the general formula (G1) or the general formula (G1-1) is represented by any one of the following structural formulae (s11) to (s18).

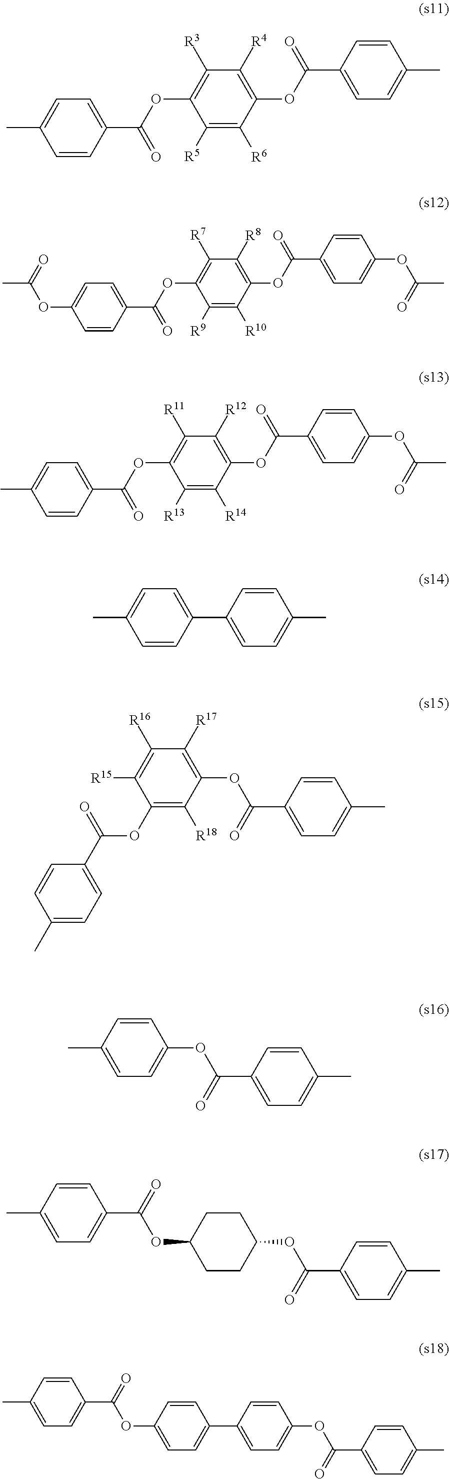

Note that R³ to R⁶ in the structural formula (s11), R⁷ to R¹⁰ in the structural formula (s12), R¹¹ to R¹⁴ in the structural formula (s13), and R¹⁵ to R¹⁸ in the structural formula (s15) individually represent any one of hydrogen, a methyl group, and fluorine.

Note that in the above structures, the liquid crystalline monomer represented by the general formula (G1) or the general formula (G1-1) has a structure represented by the following structural formula (104).

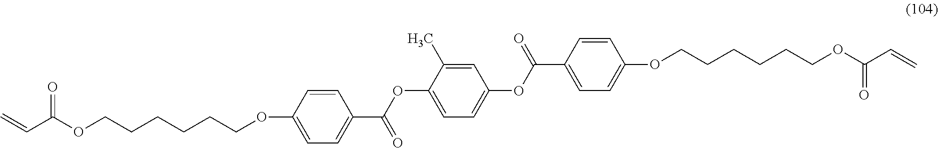

Note that in the above structures, the liquid crystalline monomer represented by the general formula (G1) or the general formula (G1-1) has a structure represented by the following structural formula (102).

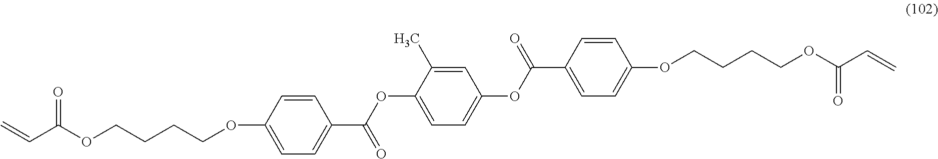

Note that in one embodiment of the present invention, polymer stabilization treatment (polymerization treatment) is performed with the use of, as a liquid crystalline monomer included in a liquid crystal composition, a liquid crystalline monomer which is represented by the general formula (G1) or the general formula (G1-1), which includes an oxyalkylene group whose chain length (the sum of carbon atoms and oxygen atoms) is n (n is greater than or equal to 2 and less than or equal to 11), and which has a lower phase transition temperature from a nematic phase to an isotropic phase (T_{NI}) than a liquid crystalline monomer which includes the oxyalkylene group whose chain length (the sum of carbon atoms and oxygen atoms) is (n−1) and a liquid crystalline monomer including the oxyalkylene group whose chain length (the sum of carbon atoms and oxygen atoms) is (n+1).

As for the liquid crystalline monomer represented by the general formula (G1) or the general formula (G1-1), since a liquid crystalline monomer which includes an oxyalkylene group whose chain length (the sum of carbon atoms and oxygen atoms) is an odd number has a low phase transition temperature from a nematic phase to an isotropic phase (T_{NI}) as compared to the case where the chain length (the sum of carbon atoms and oxygen atoms) of the oxyalkylene group is an even number, polymer stabilization treatment (polymerization treatment) is preferably performed with the use of a liquid crystalline monomer which includes an oxyalkylene group whose chain length (the sum of carbon atoms and oxygen atoms) is n (n is greater than or equal to 2 and less than or equal to 11) and whose chain length (the sum of carbon atoms and oxygen atoms) is an odd number.

Note that “a liquid crystal composition exhibiting a blue phase” in this specification refers to a liquid crystal composition which has an optical modulation effect and in which liquid crystal is optically isotropic when no voltage is applied, whereas the alignment state is changed and thus the liquid crystal becomes optically anisotropic by voltage application.

In the above structure, as the liquid crystal material exhibiting a blue phase in the liquid crystal composition, there are a nematic liquid crystal compound and a smectic liquid crystal compound, and the nematic liquid crystal compound is preferred. Note that the nematic liquid crystal compound is not particularly limited, and examples thereof are a biphenyl-based compound, a terphenyl-based compound, a phenylcyclohexyl-based compound, a biphenylcyclohexyl-based compound, a phenylbicyclohexyl-based compound, a benzoic acid phenyl-based compound, a cyclohexyl benzoic acid phenyl-based compound, a phenyl benzoic acid phenyl-based compound, a bicyclohexyl carboxylic acid phenyl-based compound, an azomethine-based compound, an azo and azoxy based compound, a stilbene-based compound, a bicyclohexyl-based compound, a phenylpyrimidine-based compound, a biphenylpyrimidine-based compound, a pyrimidine-based compound, and a biphenyl ethyne-based compound.

In the above structure, as an example of a non-liquid-crystalline monomer included in the liquid crystal composition, a monomer including a polymerizable group such as an acryloyl group, a methacryloyl group, a vinyl group, an epoxy group, a fumarate group, or a cinnamoyl group in a molecular structure is given, for example.

In the above structure, examples of a polymerization initiator included in the liquid crystal composition are acetophenone, benzophenone, benzoin, benzil, Michler's ketone, benzoin alkyl ether, benzyl dimethylketal, and thioxanthone.

Another embodiment of the present invention is a polymer/liquid crystal composite formed with the use of a liquid crystal composition including a liquid crystal material exhibiting a blue phase and the liquid crystalline monomer. Note that the liquid crystal composition may include a non-liquid-crystalline monomer and a polymerization initiator.

Another embodiment of the present invention is a liquid crystal element formed with the use of a liquid crystal composition including a liquid crystal material exhibiting a blue phase and the liquid crystalline monomer. Note that the liquid crystal composition may include a non-liquid-crystalline monomer and a polymerization initiator.

Another embodiment of the present invention is a liquid crystal element including a polymer/liquid crystal composite formed by polymerizing a liquid crystal composition including a liquid crystal material exhibiting a blue phase and the liquid crystalline monomer. Note that the liquid crystal composition may include a non-liquid-crystalline monomer and a polymerization initiator.

Another embodiment of the present invention is a liquid crystal display device formed with the use of a liquid crystal composition including a liquid crystal material exhibiting a blue phase and the liquid crystalline monomer. Note that the liquid crystal composition may include a non-liquid-crystalline monomer and a polymerization initiator.

Another embodiment of the present invention is a liquid crystal display device including a polymer/liquid crystal composite formed by polymerizing a liquid crystal composition including a liquid crystal material exhibiting a blue phase and the liquid crystalline monomer. Note that the liquid crystal composition may include a non-liquid-crystalline monomer and a polymerization initiator.

According to one embodiment of the present invention, a liquid crystal composition with which generation of an alignment defect in a polymer/liquid crystal composite exhibiting a polymer-stabilized blue phase can be reduced can be provided. Further, a liquid crystal element including a polymer/liquid crystal composite which is obtained by polymerization of the above liquid crystal composition and exhibits a polymer-stabilized blue phase can be provided. Furthermore, a liquid crystal display device including a polymer/liquid crystal composite which is obtained by polymerization of the above liquid crystal composition and exhibits a polymer-stabilized blue phase can be provided. The use of the liquid crystal composition which is one embodiment of the present invention can also decrease the driving voltage of the liquid crystal element, which leads to a decrease in driving voltage of the liquid crystal display device.

### BRIEF DESCRIPTION OF THE DRAWINGS

FIGS. 1A and 1B illustrate a liquid crystalline monomer.

FIG. 2 illustrates one mode of a liquid crystal element.

FIGS. 3A and 3B illustrate one mode of a liquid crystal display device.

FIGS. 4A1, 4A2, and 4B illustrate modes of a liquid crystal display device.

FIGS. 5A and 5B illustrate an application example of a liquid crystal display device.

FIGS. 6A to 6E illustrate application examples of a liquid crystal display device.

FIGS. 7A to 7C illustrate an application example of a liquid crystal display device.

FIG. 8 shows measurement results of a phase transition temperature from a nematic phase to an isotropic phase (T_{NI}) of a liquid crystalline monomer.

FIGS. 9A-1, 9A-2, 9B-1, 9B-2, 9C-1, 9C-2, 9D-1, 9D-2, 9E-1, and 9E-2 show textures of liquid crystal cells exhibiting a polymer-stabilized blue phase.

FIGS. 10A to 10C are each a photograph showing an appearance of a liquid crystal display device.

### DETAILED DESCRIPTION OF THE INVENTION

Hereinafter, embodiments and examples of the present invention will be described in detail with reference to the accompanying drawings. Note that the present invention is not limited to the following description, and various changes and modifications can be made without departing from the spirit and scope of the present invention. Therefore, the present invention should not be interpreted as being limited to the description in the following embodiments and examples.

Note that a liquid crystal display device in this specification refers to an image display device, a display device, or a light source (including a lighting device). Further, the liquid crystal display device includes any of the following modules in its category: a module to which a connector such as a flexible printed circuit (FPC) or a tape carrier package (TCP) is attached; a module having a TCP which is provided with a printed wiring board at the end thereof; and a module having an integrated circuit (IC) directly mounted on a display element by a chip on glass (COG) method.

### Embodiment 1

In this embodiment, a liquid crystal composition exhibiting a polymer-stabilized blue phase, and a polymer/liquid crystal composite obtained by polymer stabilization treatment (polymerization treatment) of the liquid crystal composition will be described.

The liquid crystal composition described in this embodiment includes a liquid crystal material exhibiting a blue phase, a liquid crystalline monomer, a non-liquid-crystalline monomer, and a polymerization initiator.

The liquid crystal material exhibiting a blue phase refers to a liquid crystal material capable of exhibiting a so-called blue phase that substantially does not scatter light and is optically isotropic. As the liquid crystal material exhibiting a blue phase, there are a nematic liquid crystal compound and a smectic liquid crystal compound, and the nematic liquid crystal compound is preferred. Note that the nematic liquid crystal compound is not particularly limited, and examples thereof are a biphenyl-based compound, a terphenyl-based compound, a phenylcyclohexyl-based compound, a biphenylcyclohexyl-based compound, a phenylbicyclohexyl-based compound, a benzoic acid phenyl-based compound, a cyclohexyl benzoic acid phenyl-based compound, a phenyl benzoic acid phenyl-based compound, a bicyclohexyl carboxylic acid phenyl-based compound, an azomethine-based compound, an azo and azoxy based compound, a stilbene-based compound, a bicyclohexyl-based compound, a phenylpyrimidine-based compound, a biphenylpyrimidine-based compound, a pyrimidine-based compound, and a biphenyl ethyne-based compound.

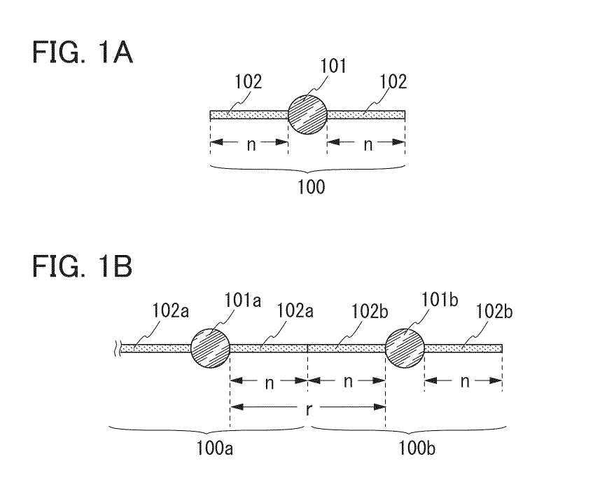

The liquid crystalline monomer has liquid crystallinity and is a monomer that can be polymerized by photopolymerization or thermopolymerization, for example. Specifically, the liquid crystalline monomer has a mesogenic skeleton 101 and oxyalkylene groups 102 at its both ends as illustrated in FIG. 1A. Note that a mesogenic skeleton in this specification refers to a highly rigid unit having two or more rings such as aromatic rings. In FIG. 1A, the chain length of the oxyalkylene group 102 is denoted by n.

A polymer obtained by polymerization of the liquid crystalline monomer illustrated in FIG. 1A has a structure shown in FIG. 1B, for example. Accordingly, when a liquid crystalline monomer 100a is polymerized with a liquid crystalline monomer 100b, the length (r) between a mesogenic skeleton 101a of the liquid crystalline monomer 100a and a mesogenic skeleton 101b of the liquid crystalline monomer 100b is represented as 2n.

Note that in one embodiment of the present invention, when polymer stabilization treatment (polymerization treatment) of a liquid crystal composition is performed, the length (r) between mesogenic skeletons at the time of polymerization of liquid crystalline monomers included in the liquid crystal composition preferably lies in a certain range. That is, the chain length of the oxyalkylene group 102 that is a side chain of the liquid crystalline monomer preferably lies in a certain range. The reason of this is as follows: in the case where the chain length of the oxyalkylene group 102 that is the side chain of the liquid crystalline monomer is longer, the viscosity of the liquid crystal composition decreases and thus phase separation in the liquid crystal composition more easily occurs; and further, in a polymerization process of polymer stabilization treatment (polymerization treatment), when the length (r) between the mesogenic skeletons is too short, the viscosity in the polymerization of the liquid crystalline monomers increases and thus the phase separation is less likely to occur due to molecular interaction between the mesogenic skeletons, so that it becomes difficult to perform polymer stabilization. On the other hand, when the length (r) between the mesogenic skeletons that are polymerized is too long, a problem of the decrease in the compatibility with the liquid crystal material also occurs, for example. Further, the liquid crystalline monomer in one embodiment of the present invention shows characteristics in which the phase transition temperature from a nematic phase to an isotropic phase (T_{NI}) is alternately increased and decreased every time the chain length of the oxyalkylene group 102 that is the side chain is increased by one value, and polymer stabilization is difficult to perform due to an influence of molecular interaction as described above also when the phase transition temperature from a nematic phase to an isotropic phase (T_{NI}) is high.

As described above, the chain length (n) of the oxyalkylene group 102 that is the side chain is set in a certain range in order that the length (r) between the mesogenic skeletons at the time of polymerization of the liquid crystalline monomers is in a certain range, and a liquid crystal composition including a liquid crystalline monomer whose phase transition temperature from a nematic phase to an isotropic phase (T_{NI}) is low is used; accordingly, when polymer stabilization treatment (polymerization treatment) is performed, molecular interaction between the mesogenic skeletons is prevented, phase separation in the liquid crystal composition occurs easily, and generation of an alignment defect in a polymer/liquid crystal composite exhibiting a polymer-stabilized blue phase can be reduced.

The liquid crystal composition that is one embodiment of the preset invention includes at least a liquid crystal material exhibiting a blue phase; and a liquid crystalline monomer. In the liquid crystalline monomer, the chain length (the sum of carbon atoms and oxygen atoms) of an oxyalkylene group represented as Y in the following general formula (G1) is n (n is greater than or equal to 2 and less than or equal to 11). The liquid crystalline monomer has a lower phase transition temperature from a nematic phase to an isotropic phase (T_{NI}) than liquid crystalline monomers including the oxyalkylene groups whose chain lengths (the sum of carbon atoms and oxygen atoms) are (n−1) and (n+1). Note that the liquid crystal composition may include a non-liquid-crystalline monomer and a polymerization initiator.

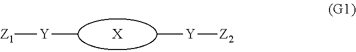

In the general formula (G1), X represents a mesogenic skeleton. Further, in the general formula (G1), Y represents an oxyalkylene group (including carbon and oxygen), and the chain length (the sum of carbon atoms and oxygen atoms) n of Y is greater than or equal to 2 and less than or equal to 11 that enables the liquid crystallinity to be maintained and does not decrease the compatibility between the liquid crystalline monomer and the liquid crystal material exhibiting a blue phase. Note that Y includes hydrogen or fluorine. Furthermore, in the general formula (G1), Z₁ and Z₂ individually represent an acryloyl group or a methacryloyl group.

As examples of a structure of the mesogenic skeleton represented as X in the general formula (G1), specifically, the following structural formulae (s1) to (s8) are given.

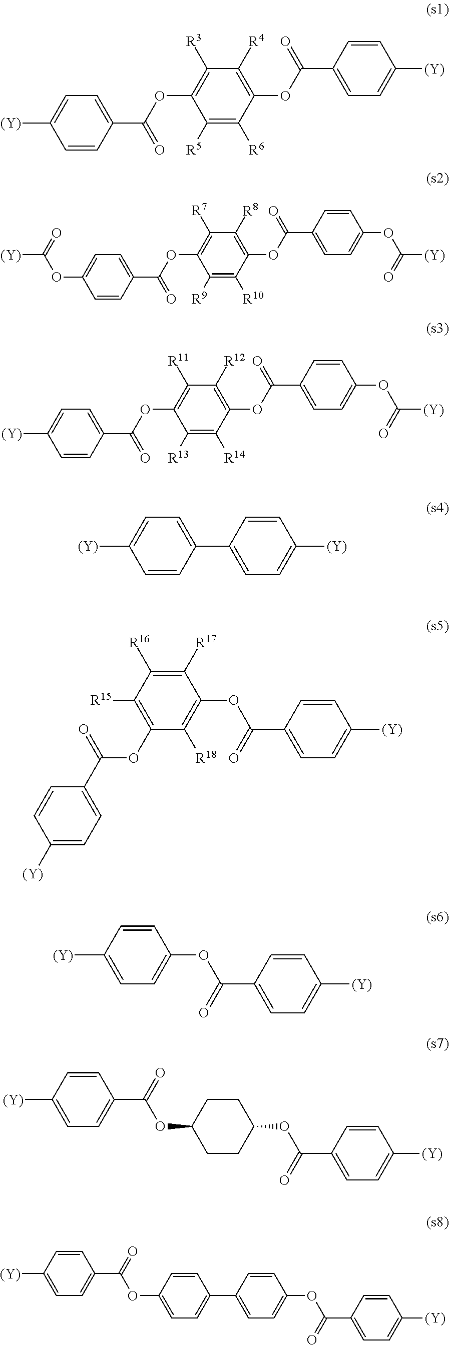

Note that (Y) in the structural formulae (s1) to (s8) represents a binding site with Y in the general formula (G1). In addition, R³ to R⁶ in the structural formula (s1), R⁷ to R¹⁰ in the structural formula (s2), and R¹¹ to R¹⁴ in the structural formula (s3) individually represent any one of hydrogen, a methyl group, and fluorine.

As examples of a structure of the oxyalkylene skeleton represented as Y in the general formula (G1), specifically, the following structural formulae (t1) to (t9) are given.

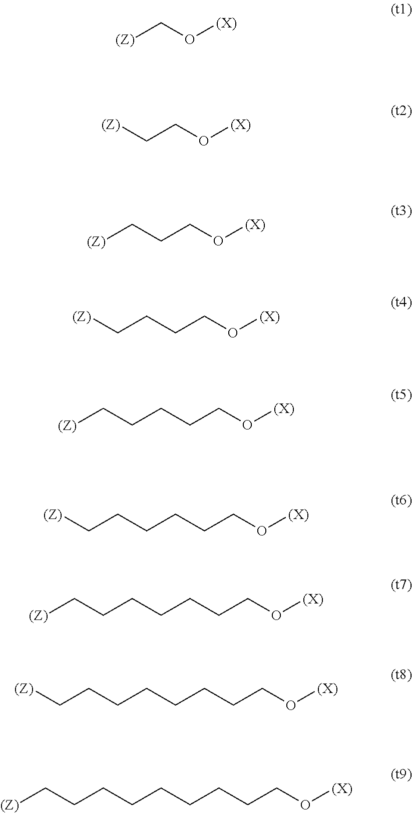

Note that (X) in the structural formulae (t1) to (t9) represents a binding site with X in the general formula (G1), and (Z) in the structural formulae (t1) to (t9) represents a binding site with Z₁ or Z₂ in the general formula (G1). In the oxyalkylene group represented by the structural formulae (t1) to (t9), (Z) may be bonded to the site indicated by (X), and (X) may be bonded to the site indicated by (Z).

As a structure represented as Z₁ or Z₂ in the general formula (G1), specifically, the following structural formulae (u1), (u2), and the like are given.

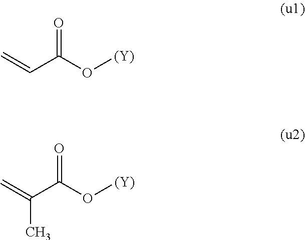

The liquid crystal composition that is one embodiment of the preset invention includes at least a liquid crystal material exhibiting a blue phase; and a liquid crystalline monomer. In the liquid crystalline monomer, the chain length (the sum of carbon atoms and oxygen atoms) of an oxyalkylene group ((—O—(CH₂)ₘ—), m is an integer) in the following general formula (G1-1) is n (n=m+1, and n is greater than or equal to 2 and less than or equal to 11). The liquid crystalline monomer has a lower phase transition temperature from a nematic phase to an isotropic phase (T_{NI}) than liquid crystalline monomers including the oxyalkylene groups whose chain lengths (the sum of carbon atoms and oxygen atoms) are (n−1) and (n+1). Note that the liquid crystal composition may include a non-liquid-crystalline monomer and a polymerization initiator.

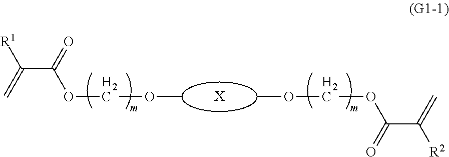

In the general formula (G1-1), X represents a mesogenic skeleton. Further, in the general formula (G1-1), m is greater than or equal to 1 and less than or equal to 10 that enables the liquid crystallinity to be maintained and does not decrease the compatibility between the liquid crystalline monomer and the liquid crystal material exhibiting a blue phase. Furthermore, in the general formula (G1-1), R¹ and R² individually represent hydrogen or a methyl group.

As examples of a structure represented as X in the general formula (G1-1), specifically, the following structural formulae (s11) to (s18) are given.

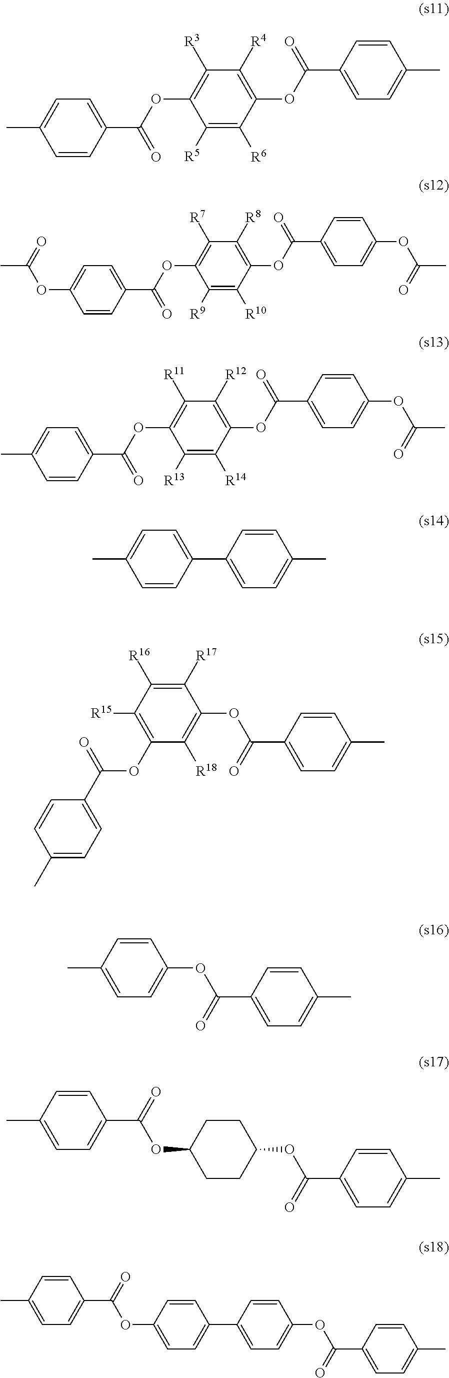

Note that R³ to R⁶ in the structural formula (s11), R⁷ to R¹⁰ in the structural formula (s12), R¹¹ to R¹⁴ in the structural formula (s13), and R¹⁵ to R¹⁸ in the structural formula (s15) individually represent any one of hydrogen, a methyl group, and fluorine.

As specific examples of the liquid crystalline monomer represented by the general formula (G1) or the general formula (G1-1), liquid crystalline monomers represented by structural formulae (100) to (109) are given. However, the present invention is not limited thereto.

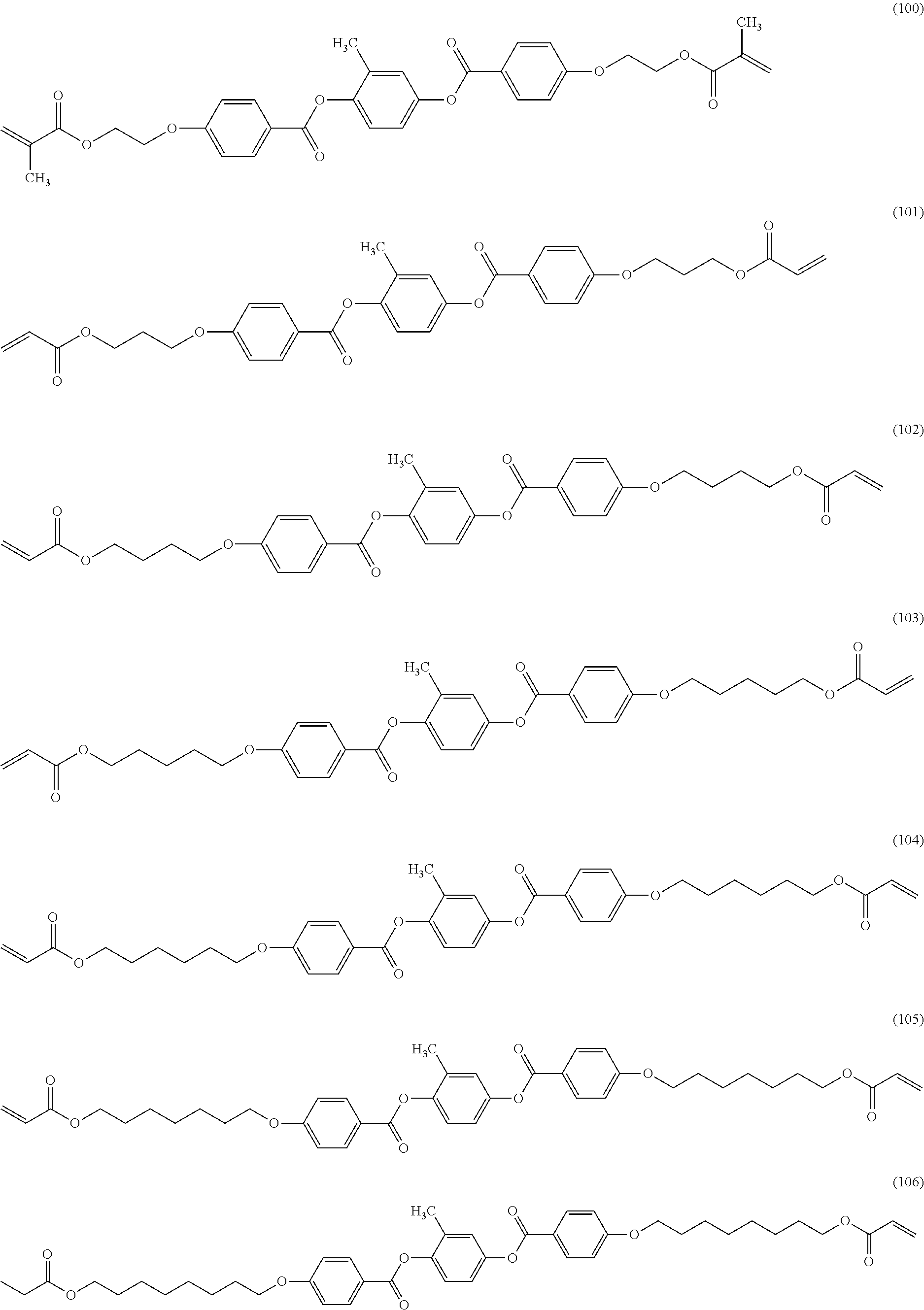

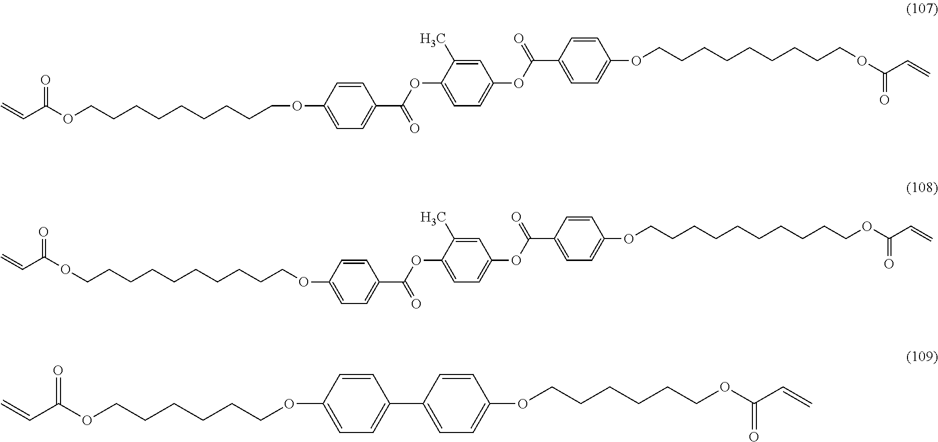

Note that the structural formula (100) represents 1,4-bis[4-(2-methacryloyloxyethyl-1-oxy)benzoyloxy]-2-methylbenzene (abbreviation: MeRM-O2), which is a liquid crystalline monomer including an oxyalkylene group whose chain length (the sum of carbon atoms and oxygen atoms) n is 3.

The structural formula (101) represents 1,4-bis[4-(3-acryloyloxypropyl-1-oxy)benzoyloxy]-2-methylbenzene (abbreviation: RM-O3), which is a liquid crystalline monomer including an oxyalkylene group whose chain length (the sum of carbon atoms and oxygen atoms) n is 4.

The structural formula (102) represents 1,4-bis[4-(4-acryloyloxybutyl-1-oxy)benzoyloxy]-2-methylbenzene (abbreviation: RM-O4), which is a liquid crystalline monomer including an oxyalkylene group whose chain length (the sum of carbon atoms and oxygen atoms) n is 5.

The structural formula (103) represents 1,4-bis[4-(5-acryloyloxypentyl-1-oxy)benzoyloxy]-2-methylbenzene (abbreviation: RM-O5), which is a liquid crystalline monomer including an oxyalkylene group whose chain length (the sum of carbon atoms and oxygen atoms) n is 6.

The structural formula (104) represents 1,4-bis[4-(6-acryloyloxyhexyl-1-oxy)benzoyloxy]-2-methylbenzene (abbreviation: RM-O6), which is a liquid crystalline monomer including an oxyalkylene group whose chain length (the sum of carbon atoms and oxygen atoms) n is 7.

The structural formula (105) represents 1,4-bis[4-(7-acryloyloxyheptyl-1-oxy)benzoyloxy]-2-methylbenzene (abbreviation: RM-O7), which is a liquid crystalline monomer including an oxyalkylene group whose chain length (the sum of carbon atoms and oxygen atoms) n is 8.

The structural formula (106) represents 1,4-bis[4-(8-acryloyloxyoctyl-1-oxy)benzoyloxy]-2-methylbenzene (abbreviation: RM-O8), which is a liquid crystalline monomer including an oxyalkylene group whose chain length (the sum of carbon atoms and oxygen atoms) n is 9.

The structural formula (107) represents 1,4-bis[4-(9-acryloyloxynonyl-1-oxy)benzoyloxy]-2-methylbenzene (abbreviation: RM-O9), which is a liquid crystalline monomer including an oxyalkylene group whose chain length (the sum of carbon atoms and oxygen atoms) n is 10.

The structural formula (108) represents 1,4-bis[4-(10-acryloyloxydecyl-1-oxy)benzoyloxy]-2-methylbenzene (abbreviation: RM-O10), which is a liquid crystalline monomer including an oxyalkylene group whose chain length (the sum of carbon atoms and oxygen atoms) n is 11.

The structural formula (109) represents 4,4′-bis(6-acryloyloxyhexyl-1-oxy)-1,1′-biphenyl (abbreviation: Dac-PP-O6), which is a liquid crystalline monomer including an oxyalkylene group whose chain length (the sum of carbon atoms and oxygen atoms) n is 7.

A non-liquid-crystalline monomer indicates a monomer that does not have liquid crystallinity, can undergo polymerization through photopolymerization or thermopolymerization, and does not have a rod-shaped molecular structure (for example, a molecular structure with an alkyl group, a cyano group, fluorine or the like attached to a terminus of a biphenyl group, a biphenylcyclohexyl group, or the like). Specifically, monomers containing polymerizable groups such as acryloyl groups, methacryloyl groups, vinyl groups, epoxy groups, fumarate groups, cinnamoyl groups, and the like are cited; however, the non-liquid-crystalline monomer is not limited to these examples.

As the polymerization reaction, photopolymerization reaction or thermopolymerization reaction may be employed, and photopolymerization reaction is preferred. In particular, photopolymerization reaction with ultraviolet light is preferred. Therefore, as a polymerization initiator, acetophenone, benzophenone, benzoin, benzil, Michler's ketone, benzoin alkyl ether, benzyl dimethylketal, or thioxanthone can be used as appropriate, for example. Note that after the polymer stabilization treatment, the polymerization initiator becomes an impurity that does not contribute to operation of a liquid crystal display device in the polymer/liquid crystal composite; therefore, as necessary, the amount of the polymerization initiator is preferably as small as possible. For example, the amount of the polymerization initiator is preferably less than or equal to 0.5 wt % in the liquid crystal composition.

The liquid crystal composition may contain a chiral material, in addition to the liquid crystal material exhibiting a blue phase, the liquid crystalline monomer, the non-liquid-crystalline monomer, and the polymerization initiator. Note that a chiral material is a material with which a twist structure is caused in a liquid crystal material. The additive amount of the chiral material influences the diffraction wavelength of the liquid crystal material exhibiting a blue phase. Therefore, the additive amount of the chiral material is preferably adjusted so that the diffraction wavelength of the liquid crystal material exhibiting a blue phase is out of a visible region (380 nm to 750 nm). As the chiral material, S-811 (produced by Merck Ltd.), S-1011 (produced by Merck Ltd.), 1,4:3,6-dianhydro-2,5-bis[4-(n-hexyl-1-oxy)benzoic acid]sorbitol (abbreviation: ISO-(6OBA)₂) (produced by Midori Kagaku Co., Ltd.), or the like can be selected as appropriate.

The liquid crystal composition which is one embodiment of the present invention includes the above-described materials. Further, by polymer stabilization treatment (polymerization treatment) of the liquid crystal composition, the polymer/liquid crystal composite exhibiting a polymer-stabilized blue phase can be obtained.

Note that in the case where photopolymerization reaction is employed as the polymer stabilization treatment (polymerization treatment) of the liquid crystal composition, the process temperature is preferably a temperature at which the polymer/liquid crystal composite obtained by the polymer stabilization treatment (polymerization treatment) exhibits a polymer-stabilized blue phase. In particular, a temperature at which the liquid crystal composition and the polymer/liquid crystal composite can keep an isotropic phase or a blue phase is preferable. The process temperature may be a temperature at which the polymer/liquid crystal composite obtained through the polymer stabilization treatment (polymerization treatment) can keep a blue phase even though the liquid crystal composition exhibits an isotropic phase. In addition, the process temperature may be changed during the polymer stabilization treatment (polymerization treatment). In that case, the temperature is such that polymerization starts at the temperature where the liquid crystal composition exhibits an isotropic phase or a blue phase, and the polymer/liquid crystal composite exhibits a blue phase.

Within the above temperature range, photopolymerization reaction is performed by irradiation with ultraviolet light or the like. Note that a period of time for the polymerization may be adjusted depending on a material contained in the liquid crystal composition, as appropriate.

With the use of a liquid crystal composition which is one embodiment of the present invention, generation of an alignment defect in a polymer/liquid crystal composite exhibiting a polymer-stabilized blue phase can be reduced.

The methods, structures, and the like described in this embodiment can be combined as appropriate with any of the methods, structures, and the like described in the other embodiments.

### Embodiment 2

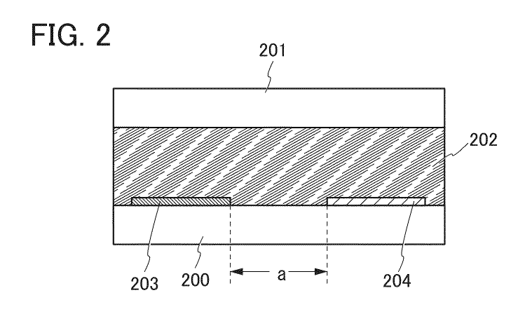

In this embodiment, an example of a liquid crystal element using the polymer/liquid crystal composite that is obtained by polymerization of the liquid crystal composition described in Embodiment 1 is described with reference to FIG. 2. FIG. 2 is a cross-sectional view of the liquid crystal element.

In FIG. 2, a liquid crystal layer 202 is formed between a first substrate 200 and a second substrate 201. The polymer/liquid crystal composite described in Embodiment 1 is used for the liquid crystal layer 202. A pixel electrode layer 203 and a common electrode layer 204 are adjacently formed over the first substrate 200.

In this embodiment, a method is used in which grayscale is controlled by generating an electric field which is substantially parallel to a substrate (i.e., in a horizontal direction) to move liquid crystal molecules in a plane parallel to the substrate (i.e., in a horizontal direction).

Note that the distance a (shown in FIG. 2) between the pixel electrode layer 203 and the common electrode layer 204, which are adjacently formed with the liquid crystal layer 202 interposed therebetween, is a distance at which liquid crystal that is included in the liquid crystal layer 202 and exists between the pixel electrode layer 203 and the common electrode layer 204 responds when given voltages are applied to the pixel electrode layer 203 and the common electrode layer 204. The applied voltage is controlled depending on the distance a as appropriate.

As the first substrate 200 and the second substrate 201, a glass substrate made of barium borosilicate glass, aluminoborosilicate glass, or the like, a quartz substrate, a plastic substrate, or the like can be used.

The pixel electrode layer 203 and the common electrode layer 204 may be formed using one or more of the following: indium tin oxide (ITO), a conductive material in which zinc oxide (ZnO) is mixed into indium oxide (indium zinc oxide), a conductive material in which silicon oxide (SiO₂) is mixed into indium oxide, organoindium, organotin, indium oxide containing tungsten oxide, indium zinc oxide containing tungsten oxide, indium oxide containing titanium oxide, and indium tin oxide containing titanium oxide; metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag); alloys thereof; and metal nitrides thereof.

The liquid crystal layer 202 can be obtained as follows: the liquid crystal composition described in Embodiment 1 is provided between the first substrate 200 and the second substrate 201 by a liquid crystal dropping method (ODF: one drop fill), a liquid crystal injection method, or the like, and then is polymerized to be a polymer/liquid crystal composite. Note that the thickness (film thickness) of the liquid crystal layer 202 is preferably greater than or equal to 1 μm and less than or equal to 20 μm.

In the above liquid crystal element, since an electric field in a horizontal direction is generated between the pixel electrode layer 203 and the common electrode layer 204, the liquid crystal molecules in the liquid crystal layer 202 can be controlled in a direction parallel to the first substrate 201.

The liquid crystal element of this embodiment can exhibit a polymer-stabilized blue phase. Further, with the use of the polymer/liquid crystal composite for the liquid crystal layer 202 in the liquid crystal element, high-speed response becomes possible and high contrast can be provided.

For the liquid crystal element of this embodiment, optical films such as a polarizing plate, a retardation plate, and an anti-reflection film can be used in combination, as appropriate. For example, circular polarization by the polarizing plate or the retardation plate may be used. In addition, a backlight or the like may be used as a light source.

Note that the liquid crystal element of this embodiment can be applied to a transmissive liquid crystal display device in which display is performed by transmission of light from a light source, a reflective liquid crystal display device in which display is performed by reflection of incident light, or a semi-transmissive liquid crystal display device in which a transmissive type and a reflective type are combined.

### Embodiment 3

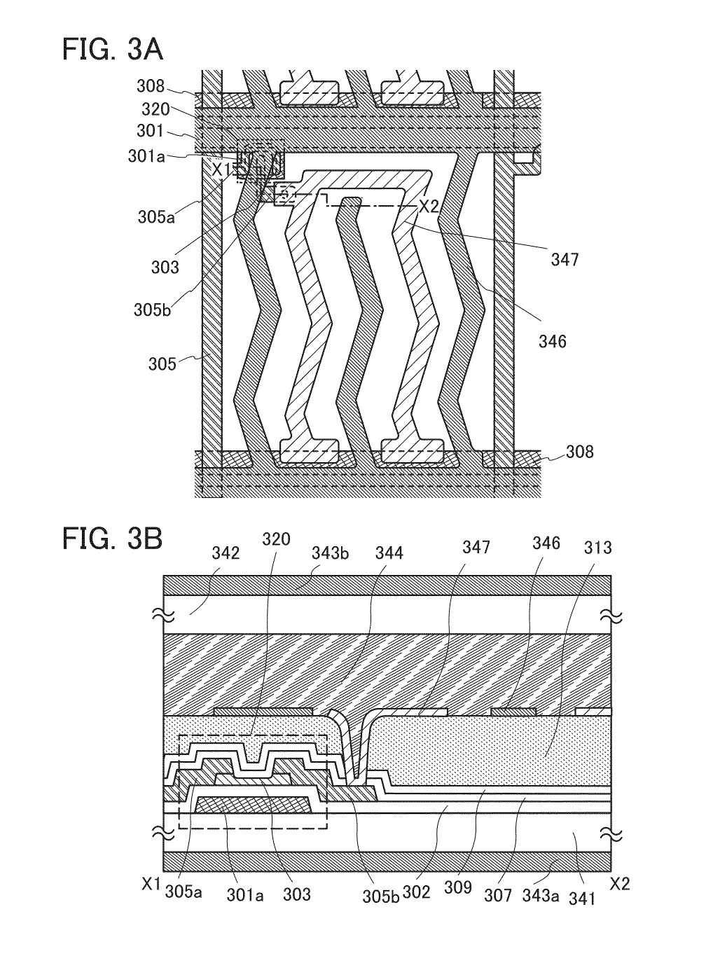

In this embodiment, a liquid crystal display device in which a liquid crystal composition that is one embodiment of the present invention is used for a liquid crystal layer is described. Note that the liquid crystal display device of this embodiment includes the liquid crystal element (also referred to as liquid crystal display element) described in Embodiment 2 as a display element. The liquid crystal display device may be a passive matrix liquid crystal display device or an active matrix liquid crystal display device, and in this embodiment, the case where the liquid crystal element is applied to an active matrix liquid crystal display device will be described with reference to FIGS. 3A and 3B.

FIG. 3A is a plan view of the liquid crystal display device and illustrates one pixel. FIG. 3B is a cross-sectional view taken along dashed-dotted line X1-X2 in FIG. 3A.

In FIG. 3A, a plurality of source wiring layers 305 (including a wiring layer 305a) is arranged so as to be parallel to (extend in the longitudinal direction in FIG. 3A) and apart from each other. A plurality of gate wiring layers 301 (including a gate electrode layer 301a) is arranged so as to be extended in a direction perpendicular to or substantially perpendicular to the source wiring layers 305 (in the horizontal direction in FIG. 3A) and apart from each other. A plurality of common wiring layers 308 is provided so as to be adjacent to the respective gate wiring layers 301 and extended in a direction parallel to the gate wiring layers 301, that is, in a direction substantially perpendicular to the source wiring layers 305 (in the horizontal direction in FIG. 3A). A pixel electrode layer 347 and a common electrode layer 346 of the liquid crystal display device are arranged in a space surrounded by the source wiring layers 305, the common wiring layers 308, and the gate wiring layers 301. Note that the pixel electrode layer 347 is electrically connected to a transistor 320, and the transistor 320 is provided in each pixel.

In the liquid crystal display device of FIG. 3A, a capacitor is formed by the pixel electrode layer 347 and the common wiring layer 308. Although the common wiring layer 308 can operate in a floating state (electrically isolated state), the potential of the common wiring layer 308 may be set to a fixed potential, preferably to a potential around a common potential (intermediate potential of an image signal which is transmitted as data) at such a level as not to generate flickers.

In the electrode structure in the liquid crystal display device of FIGS. 3A and 3B, the pixel electrode layer 347 and the common electrode layer 346 are formed in one plane that is parallel to the substrate. A method in which grayscale is controlled by generating an electric field in the direction parallel to a substrate to move liquid crystal molecules in a plane parallel to the substrate (i.e., an IPS mode) can be applied to the electrode structure.

Next, a cross-sectional structure of the liquid crystal display device shown in FIG. 3B is described. The liquid crystal display device shown in FIG. 3B has a structure in which a liquid crystal layer 344 is provided between a second substrate 342 and a first substrate 341 including the transistor 320, the pixel electrode layer 347, the common electrode layer 346, and the like. Further, polarizing plates 343a and 343b are provided in contact with the first substrate 341 and the second substrate 342, respectively.

The transistor 320 is an inverted staggered thin film transistor in which the gate electrode layer 301a, a gate insulating layer 302, a semiconductor layer 303, and wiring layers 305a and 305b which function as a source electrode layer and a drain electrode layer are formed over the first substrate 341 having an insulating surface.

There is no particular limitation on the structure of a transistor which can be used for a liquid crystal display device described in this embodiment. For example, a staggered type or a planar type having a top-gate structure or a bottom-gate structure can be employed. The transistor may have a single-gate structure in which one channel formation region is formed, a double-gate structure in which two channel formation regions are formed, or a triple-gate structure in which three channel formation regions are formed. Alternatively, the transistor may have a dual-gate structure including two gate electrode layers positioned over and below a channel region with a gate insulating layer interposed therebetween.

In FIG. 3B, the gate electrode layer 301a is formed over the first substrate 341. The gate electrode layer 301a can be formed to have a single-layer structure or a layered structure using any of metal materials such as molybdenum, titanium, chromium, tantalum, tungsten, aluminum, copper, neodymium, and scandium, and an alloy material which contains any of these materials as its main component. By using a light-blocking conductive film as the gate electrode layer 301a, light from a backlight (light emitted through the first substrate 341) can be prevented from entering the semiconductor layer 303.

The gate electrode layer 301a may have a layered structure. For example, in the case where the gate electrode layer 301a has a two-layer structure, a two-layer structure in which a molybdenum layer is stacked over an aluminum layer, a two-layer structure in which a molybdenum layer is stacked over a copper layer, a two-layer structure in which a titanium nitride layer or a tantalum nitride layer is stacked over a copper layer, or a two-layer structure in which a titanium nitride layer and a molybdenum layer are stacked is preferable. In the case where the gate electrode layer 301a has a three-layer structure, a layered structure of a tungsten layer or a tungsten nitride layer, a layer of an alloy of aluminum and silicon or a layer of an alloy of aluminum and titanium, and a titanium nitride layer or a titanium layer is preferable.

Note that a base film formed of an insulating film may be provided between the first substrate 341 and the gate electrode layer 301a. The base film has a function of preventing diffusion of an impurity element from the first substrate 341, and can be formed to have a single-layer structure or a layered structure using one or more of a silicon nitride film, a silicon oxide film, a silicon nitride oxide film, and a silicon oxynitride film.

The gate insulating layer 302 can be formed to have a single-layer structure or a layered structure using any of a silicon oxide layer, a silicon nitride layer, a silicon oxynitride layer, and a silicon nitride oxide layer by a plasma CVD method, a sputtering method, or the like. Alternatively, a silicon oxide layer formed by a CVD method using an organosilane gas can be used as the gate insulating layer 302. As an organosilane gas, a silicon-containing compound such as tetraethoxysilane (TEOS) (chemical formula: Si(OC₂H₅)₄), tetramethylsilane (TMS) (chemical formula: Si(CH₃)₄), tetramethylcyclotetrasiloxane (TMCTS), octamethylcyclotetrasiloxane (OMCTS), hexamethyldisilazane (HMDS), triethoxysilane (SiH(OC₂H₅)₃), or trisdimethylaminosilane (SiH(N(CH₃)₂)₃) can be used.

A material of the semiconductor layer 303 is not particularly limited and may be determined as appropriate depending on characteristics needed for the transistor 320. The semiconductor layer 303 can be formed using the following material: an amorphous semiconductor manufactured by a sputtering method or a vapor-phase growth method using a semiconductor source gas typified by silane or germane; a polycrystalline semiconductor formed by crystallizing the amorphous semiconductor with the use of light energy or thermal energy; a microcrystalline semiconductor; an oxide semiconductor; or the like.

A typical example of an amorphous semiconductor is hydrogenated amorphous silicon, while a typical example of a crystalline semiconductor is polysilicon. Examples of polysilicon (polycrystalline silicon) are as follows: high-temperature polysilicon which contains polysilicon formed at a process temperature of 800° C. or higher as its main component, low-temperature polysilicon which contains polysilicon formed at a process temperature of 600° C. or lower as its main component, and polysilicon obtained by crystallizing amorphous silicon with the use of an element that promotes crystallization, or the like. It is needless to say that a microcrystalline semiconductor or a semiconductor containing a crystal phase in part of a semiconductor layer can be used as described above.

Further, as an oxide semiconductor, an oxide of four metal elements such as an In—Sn—Ga—Zn-based oxide semiconductor; an oxide of three metal elements such as an In—Ga—Zn-based oxide semiconductor, an In—Sn—Zn-based oxide semiconductor, an In—Al—Zn-based oxide semiconductor, a Sn—Ga—Zn-based oxide semiconductor, an Al—Ga—Zn-based oxide semiconductor, or a Sn—Al—Zn-based oxide semiconductor; or an oxide of two metal elements such as an In—Zn-based oxide semiconductor, a Sn—Zn-based oxide semiconductor, an Al—Zn-based oxide semiconductor, a Zn—Mg-based oxide semiconductor, a Sn—Mg-based oxide semiconductor, an In—Mg-based oxide semiconductor, or an In—Ga-based oxide semiconductor; an In-based oxide semiconductor; a Sn-based oxide semiconductor; or a Zn-based oxide semiconductor can be used. Further, SiO₂ may be contained in the above oxide semiconductor. Here, for example, an In—Ga—Zn-based oxide semiconductor is an oxide containing at least In, Ga, and Zn, and there is no particular limitation on the composition thereof. Further, the In—Ga—Zn-based oxide semiconductor may contain an element other than In, Ga, and Zn.

As the oxide semiconductor, a thin film expressed by the chemical formula, InMO₃(ZnO)ₘ (m>0), can be used. Here, M represents one or more metal elements selected from Ga, Al, Mn, and Co. For example, M can be Ga, Ga and Al, Ga and Mn, or Ga and Co. Further, as the oxide semiconductor, a crystalline oxide semiconductor with c-axis alignment (also referred to as c-axis aligned crystalline oxide semiconductor (CAAC-OS)), which has neither a single crystal structure nor an amorphous structure, can be used.

The semiconductor layer 303 can be formed by a sputtering method, an LPCVD method, a plasma CVD method, or the like. In an etching step for processing the semiconductor layer 303 into a desired shape, dry etching or wet etching can be used.

As an etching apparatus used for the dry etching, an etching apparatus using a reactive ion etching method (RIE method), or a dry etching apparatus using a high-density plasma source such as electron cyclotron resonance (ECR) or inductively coupled plasma (ICP) can be used. As a dry etching apparatus by which uniform electric discharge can be performed over a large area as compared to an ICP etching apparatus, there is an enhanced capacitively coupled plasma (ECCP) mode apparatus in which an upper electrode is grounded, a high-frequency power source at 13.56 MHz is connected to a lower electrode, and further a low-frequency power source at 3.2 MHz is connected to the lower electrode. This ECCP mode etching apparatus can be applied, for example, even when a substrate of the tenth generation with a size of larger than approximately 3 m is used.

As a material for the wiring layers 305a and 305b which serve as the source and drain electrode layers of the transistor 320, there are an element selected from aluminum (Al), chromium (Cr), tantalum (Ta), titanium (Ti), molybdenum (Mo), tungsten (W), copper (Cu), and magnesium (Mg), an alloy containing any of these elements as a component, an alloy film in which any of these elements are combined, and the like. Further, in the case where heat treatment is performed, the conductive film preferably has heat resistance against the heat treatment. For example, since the use of aluminum (Al) alone brings disadvantages such as low heat resistance and a tendency to corrosion, aluminum (Al) is used in combination with a conductive material having heat resistance. As the conductive material having heat resistance, which is combined with aluminum, it is possible to use an element selected from titanium (Ti), tantalum (Ta), tungsten (W), molybdenum (Mo), chromium (Cr), neodymium (Nd), and scandium (Sc); an alloy containing any of these elements as its component; an alloy film containing a combination of any of these elements; or a nitride containing any of these elements as its component.

Note that the gate insulating layer 302, the semiconductor layer 303, and the wiring layers 305a and 305b may be successively formed without exposure to the air. Successive film formation without exposure to the air makes it possible to obtain each interface between stacked layers, which is not contaminated by atmospheric components or impurity elements floating in the air. Therefore, variation in characteristics of the transistor can be reduced.

As the insulating film 307 and the insulating film 309, an inorganic insulating film or an organic insulating film formed by a dry method or a wet method can be used. For example, it is possible to use a silicon nitride film, a silicon oxide film, a silicon oxynitride film, an aluminum oxide film, or a tantalum oxide film, which is formed by a CVD method, a sputtering method, or the like. Alternatively, an organic material such as polyimide, acrylic, benzocyclobutene, polyamide, or epoxy can be used. As an alternative to such organic materials, it is possible to use a low-dielectric constant material (a low-k material), a siloxane-based resin, phosphosilicate glass (PSG), borophosphosilicate glass (BPSG), or the like. A gallium oxide film can also be used as the insulating film 307.

Note that the siloxane-based resin corresponds to a resin including a Si—O—Si bond formed using a siloxane-based material as a starting material. A siloxane-based resin may include, as a substituent, an organic group (e.g., an alkyl group or an aryl group) or a fluoro group. A siloxane-based resin is applied by a coating method and baked; thus, the insulating film 307 and the insulating film 309 can be formed.

Note that the insulating film 307 and the insulating film 309 may be formed to have a layered structure including a plurality of insulating films formed using the above-described materials. For example, a structure may be employed in which an organic resin film is stacked over an inorganic insulating film.

The interlayer film 313 can be formed using the same material as the insulating film 307 and the insulating film 309. There is no particular limitation on the method for forming the interlayer film 313, and the following method can be employed depending on the material: spin coating, dip coating, spray coating, a droplet discharging method (such as an ink-jet method), a printing method (such as screen printing or offset printing), roll coating, curtain coating, knife coating, or the like.

The pixel electrode layer 347 and the common wiring layer 308 can be formed using a light-transmitting conductive material such as indium oxide containing tungsten oxide, indium zinc oxide containing tungsten oxide, indium oxide containing titanium oxide, indium tin oxide containing titanium oxide, indium tin oxide (ITO), indium zinc oxide, or indium tin oxide to which silicon oxide is added. Alternatively, the pixel electrode layer 347 and the common wiring layer 308 can be formed using one or more of the following: metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag); alloys thereof; and nitrides thereof.

Alternatively, the pixel electrode layer 347 and the common wiring layer 308 can be formed using a conductive composition including a conductive macromolecule (also referred to as a conductive polymer). The pixel electrode formed using the conductive composition preferably has a sheet resistance of 10000 Ω/square or less and a transmittance of 70% or more at a wavelength of 550 nm. Further, the resistivity of the conductive macromolecule included in the conductive composition is preferably less than or equal to 0.1 Ω·cm. As the conductive macromolecule, a so-called π-electron conjugated conductive macromolecule can be used. For example, polyaniline or a derivative thereof, polypyrrole or a derivative thereof, polythiophene or a derivative thereof, a copolymer of two or more kinds of aniline, pyrrole, and thiophene or a derivative thereof, and the like can be given.

For the liquid crystal layer 344, a liquid crystal composition according to one embodiment of the present invention is used. Note that the liquid crystal composition includes a liquid crystal material exhibiting a blue phase, a liquid crystalline monomer, a non-liquid-crystalline monomer, and a polymerization initiator. A polymer/liquid crystal composite obtained by polymer stabilization treatment (polymerization treatment) of the liquid crystal composition is used for the liquid crystal layer 344.

After the liquid crystal composition for forming the liquid crystal layer 344 is disposed between the first substrate 341 and the second substrate 342 that is a counter substrate, the first substrate 341 and the second substrate 342 are bonded to each other with a sealant although not shown here. The liquid crystal composition can be disposed between the first substrate 341 and the second substrate 342 by a liquid crystal dropping method (ODF: one drop fill) or a liquid crystal injection method in which the first substrate 341 and the second substrate 342 are bonded to each other and then the liquid crystal composition is injected using a capillary phenomenon or the like.

As the sealant, typically, a visible light curable resin, a UV curable resin, or a thermosetting resin is preferably used. Typically, an acrylic resin, an epoxy resin, an amine resin, or the like can be used. Further, a photopolymerization initiator (typically, a UV polymerization initiator), a thermosetting agent, a filler, or a coupling agent may be contained in the sealant.

After the space between the first substrate 341 and the second substrate 342 is filled with the liquid crystal composition, polymer stabilization treatment (polymerization treatment) is performed by light irradiation, whereby the liquid crystal layer 344 is formed. The light has a wavelength with which the liquid crystalline monomer, the non-liquid-crystalline monomer, and the polymerization initiator included in the liquid crystal composition react. Through the polymer stabilization treatment (polymerization treatment) by the light irradiation, the liquid crystal layer 344 is obtained. Note that in the case of using a photocurable resin as a sealant, curing of the sealant may be performed simultaneously with the polymer stabilization treatment.

Note that according to the structure of an electrode in the liquid crystal display device of this embodiment, liquid crystal molecules included in the liquid crystal layer 344 are controlled by an electric field in the horizontal direction. The polymer/liquid crystal composite is aligned so as to exhibit a blue phase, and can be controlled in the direction parallel to the substrate; thus, a wide viewing angle can be obtained.

In this embodiment, the polarizing plate 343a is provided on the outer side (on the side opposite to the liquid crystal layer 344) of the first substrate 341, and the polarizing plate 343b is provided on the outer side (on the side opposite to the liquid crystal layer 344) of the second substrate 342. In addition to the polarizing plate, an optical film such as a retardation plate or an anti-reflection film may be provided. For example, circular polarization with the polarizing plate and the retardation plate may be used.

Although not shown, a backlight, a sidelight, or the like can be used as a light source of the liquid crystal display device of this embodiment. Light from the light source is emitted from the first substrate 341 side so as to pass through the second substrate 342 on the viewing side.

In the case of manufacturing a plurality of liquid crystal display devices using a large-sized substrate (a so-called multiple panel method), a division step can be performed before the polymer stabilization treatment is performed or before the polarizing plates are provided. In consideration of the influence of the division step on the liquid crystal layer (such as disorder of an alignment state due to force applied in the division step), it is preferable that the division step be performed after the first substrate 341 and the second substrate 342 are attached to each other and before the polymer stabilization treatment is performed.

With the use of a liquid crystal composition which is one embodiment of the present invention in the liquid crystal display device described in this embodiment, generation of an alignment defect in a polymer/liquid crystal composite exhibiting a polymer-stabilized blue phase can be reduced. As a result, defects of a panel of the liquid crystal display device can be reduced, so that the yield of the liquid crystal display device can be improved. The use of the liquid crystal composition which is one embodiment of the present invention can also decrease the driving voltage of the liquid crystal element, which leads to a decrease in driving voltage of the liquid crystal display device.

In the liquid crystal display device of this embodiment, the polymer/liquid crystal composite can exhibit a polymer-stabilized blue phase and thus provide high contrast; accordingly, a liquid crystal display device with high visibility and high image quality can be provided. Further, since the liquid crystal element using a blue phase is capable of high-speed response, a liquid crystal display device with higher performance can be achieved.

This embodiment can be implemented in appropriate combination with any of the structures described in the other embodiments.

### Embodiment 4

In this embodiment, a liquid crystal display device in which a liquid crystal composition according to one embodiment of the present invention is used for a liquid crystal layer will be described. Note that the liquid crystal display device of this embodiment includes the liquid crystal element (also referred to as liquid crystal display element) described in Embodiment 2 as a display element.

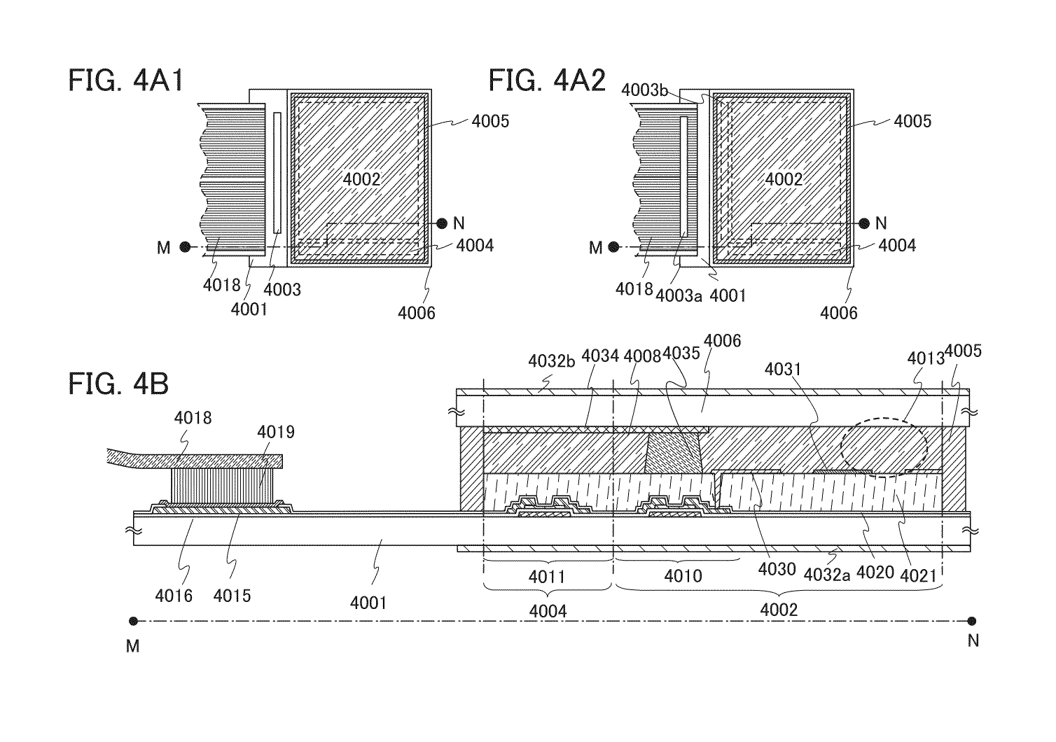

The appearance and a cross section of a liquid crystal display panel, which is one embodiment of a liquid crystal display device, will be described with reference to FIGS. 4A1, 4A2, and 4B. FIGS. 4A1 and 4A2 are each a top view of a panel in which transistors 4010 and 4011 formed over a first substrate 4001 and a liquid crystal element 4013 are sealed between the first substrate 4001 and a second substrate 4006 with a sealant 4005. FIG. 4B is a cross-sectional view taken along line M-N of FIGS. 4A1 and 4A2.

The sealant 4005 is provided to surround a pixel portion 4002 and a scanning line driver circuit 4004 that are provided over the first substrate 4001. The second substrate 4006 is provided over the pixel portion 4002 and the scanning line driver circuit 4004. Therefore, the pixel portion 4002 and the scanning line driver circuit 4004 are sealed together with a liquid crystal layer 4008, by the first substrate 4001, the sealant 4005, and the second substrate 4006.

In FIG. 4A1, a signal line driver circuit 4003 that is formed using a single crystal semiconductor film or a polycrystalline semiconductor film over a substrate separately prepared is mounted in a region different from the region surrounded by the sealant 4005 over the first substrate 4001. Note that FIG. 4A2 illustrates an example in which part of the signal line driver circuit is formed using a transistor provided over the first substrate 4001. A signal line driver circuit 4003b is formed over the first substrate 4001, and a signal line driver circuit 4003a formed using a single crystal semiconductor film or a polycrystalline semiconductor film is mounted on a substrate separately prepared.

Note that there is no particular limitation on the connection method of a driver circuit which is separately formed, and COG, wire bonding, TAB, or the like can be used. FIG. 4A1 illustrates an example of mounting the signal line driver circuit 4003 by COG, and FIG. 4A2 illustrates an example of mounting the signal line driver circuits 4003a and 4003b by TAB.

The pixel portion 4002 and the scanning line driver circuit 4004 provided over the first substrate 4001 each include a plurality of transistors. FIG. 4B illustrates the transistor 4010 included in the pixel portion 4002 and the transistor 4011 included in the scanning line driver circuit 4004. An insulating layer 4020 and an interlayer film 4021 are provided over the transistors 4010 and 4011.

As the transistors 4010 and 4011, transistors with a known structure can be used.

Further, a conductive layer may be provided over the interlayer film 4021 or the insulating layer 4020 so as to overlap with a channel formation region of a semiconductor layer of the transistor 4011 for the driver circuit. The conductive layer may have the same potential as or a potential different from that of a gate electrode layer of the transistor 4011 and can function as a second gate electrode layer. Further, the potential of the conductive layer may be GND or 0 V, or the conductive layer may be in a floating state.

A pixel electrode layer 4030 and a common electrode layer 4031 are provided over the interlayer film 4021, and the pixel electrode layer 4030 is electrically connected to the transistor 4010. The liquid crystal element 4013 includes the pixel electrode layer 4030, the common electrode layer 4031, and the liquid crystal layer 4008. Note that a polarizing plate 4032a and a polarizing plate 4032b are provided on the outer sides of the first substrate 4001 and the second substrate 4006, respectively.

The liquid crystal composition described in Embodiment 1 is used for the liquid crystal layer 4008.

With an electric field generated between the pixel electrode layer 4030 and the common electrode layer 4031, liquid crystal molecules of the liquid crystal layer 4008 are controlled. An electric field in a lateral direction is generated in the liquid crystal layer 4008, so that liquid crystal molecules can be controlled using the electric field. The liquid crystal composition described in Embodiment 1 becomes a polymer/liquid crystal composite through the polymer stabilization treatment (polymerization treatment). Liquid crystal included in the polymer/liquid crystal composite is aligned so as to exhibit a blue phase and can be controlled in the direction parallel to the substrate; thus, a wide viewing angle can be obtained.

As the first substrate 4001 and the second substrate 4006, glass, plastic, or the like having a light-transmitting property can be used. As plastic, a fiberglass-reinforced plastics (FRP) plate, a polyvinyl fluoride (PVF) film, a polyester film, or an acrylic resin film can be used. A sheet with a structure in which an aluminum foil is sandwiched between PVF films or polyester films can also be used.

A columnar spacer 4035 is obtained by selective etching of an insulating layer and is provided in order to control the thickness of the liquid crystal layer 4008 (a cell gap). Alternatively, a spherical spacer may be used. In the liquid crystal display device, the cell gap which is the thickness of the liquid crystal layer 4008 is preferably greater than or equal to 1 μm and less than or equal to 20 μm. In this specification, the cell gap refers to the maximum thickness (film thickness) of the liquid crystal layer 4008.

Although FIGS. 4A1, 4A2, and 4B illustrate transmissive liquid crystal display devices, the liquid crystal display device in the present invention may be a semi-transmissive liquid crystal display device or a reflective liquid crystal display device.

FIGS. 4A1, 4A2, and 4B illustrate examples of liquid crystal display devices in which a polarizing plate is provided on the outer side (the viewing side) of a substrate; however, the polarizing plate may be provided on the inner side of the substrate. The position of the polarizing plate may be determined as appropriate depending on the material of the polarizing plate and conditions of the manufacturing process. Furthermore, a light-blocking layer serving as a black matrix may be provided.

A color filter layer or a light-blocking layer may be formed as part of the interlayer film 4021. In FIGS. 4A1, 4A2, and 4B, a light-blocking layer 4034 is provided on the second substrate 4006 side so as to cover the transistors 4010 and 4011. By providing the light-blocking layer 4034, the contrast can be increased and the transistors can be stabilized.

The insulating layer 4020 may be provided so as to function as a protective film of the transistors; however, this embodiment is not particularly limited thereto. In that case, the protective film is provided to prevent entry of contaminant impurities such as an organic substance, metal, and moisture floating in the air and is preferably a dense film. The protective film may be formed by a sputtering method to have a single-layer structure or a layered structure including any of a silicon oxide film, a silicon nitride film, a silicon oxynitride film, a silicon nitride oxide film, an aluminum oxide film, an aluminum nitride film, an aluminum oxynitride film, and an aluminum nitride oxide film.

Further, in the case of further forming a light-transmitting insulating layer as a planarizing insulating film, the light-transmitting insulating layer can be formed using an organic material having heat resistance, such as polyimide, acrylic, benzocyclobutene, polyamide, or epoxy. As an alternative to such organic materials, it is possible to use a low-dielectric constant material (a low-k material), a siloxane-based resin, phosphosilicate glass (PSG), borophosphosilicate glass (BPSG), or the like. The insulating layer may be formed by stacking a plurality of insulating films formed of these materials.

There is no particular limitation on the method for forming the insulating layer having a layered structure, and the following method can be employed depending on the material: sputtering, spin coating, dip coating, spray coating, a droplet discharging method (such as an ink-jet method), a printing method (such as screen printing or offset printing), roll coating, curtain coating, knife coating, or the like.

The pixel electrode layer 4030 and the common electrode layer 4031 can be formed using a light-transmitting conductive material such as indium oxide containing tungsten oxide, indium zinc oxide containing tungsten oxide, indium oxide containing titanium oxide, indium tin oxide containing titanium oxide, indium tin oxide (ITO), indium zinc oxide, or indium tin oxide to which silicon oxide is added. Alternatively, the pixel electrode layer 4030 and the common electrode layer 4031 can be formed using one or more of the following: metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag); alloys thereof; and nitrides thereof.

Alternatively, the pixel electrode layer 4030 and the common electrode layer 4031 can be formed using a conductive composition including a conductive macromolecule (also referred to as a conductive polymer).

Further, a variety of signals and potentials are supplied to the signal line driver circuit 4003 which is formed separately, the scanning line driver circuit 4004, or the pixel portion 4002 from an FPC 4018.

Further, since the transistor is easily broken by static electricity or the like, a protective circuit for protecting the driver circuits is preferably provided over the same substrate as a gate line or a source line. The protective circuit is preferably formed using a nonlinear element.

In FIGS. 4A1, 4A2, and 4B, a connection terminal electrode 4015 is formed using the same conductive film as the pixel electrode layer 4030, and a terminal electrode 4016 is formed using the same conductive film as source electrode layers and drain electrode layers of the transistors 4010 and 4011. The connection terminal electrode 4015 is electrically connected to a terminal included in the FPC 4018 through an anisotropic conductive film 4019.

Although FIGS. 4A1, 4A2, and 4B illustrate an example in which the signal line driver circuit 4003 is formed separately and mounted on the first substrate 4001, one embodiment of the present invention is not limited to this structure. The scanning line driver circuit may be separately formed and then mounted, or only part of the signal line driver circuit or part of the scanning line driver circuit may be separately formed and then mounted.

With the use of a liquid crystal composition which is one embodiment of the present invention in the liquid crystal display device described in this embodiment, generation of an alignment defect in a polymer/liquid crystal composite exhibiting a polymer-stabilized blue phase can be reduced. As a result, defects of a panel of the liquid crystal display device can be reduced, so that the yield of the liquid crystal display device can be improved. The use of the liquid crystal composition which is one embodiment of the present invention can also decrease the driving voltage of the liquid crystal element, which leads to a decrease in driving voltage of the liquid crystal display device.

In the liquid crystal display device of this embodiment, the polymer/liquid crystal composite can exhibit a polymer-stabilized blue phase and thus provide high contrast; accordingly, a liquid crystal display device with high visibility and high image quality can be provided. Further, since the liquid crystal element using a blue phase is capable of high-speed response, a liquid crystal display device with higher performance can be achieved.

This embodiment can be implemented in appropriate combination with any of the structures described in the other embodiments.

### Embodiment 5

A liquid crystal display device disclosed in this specification can be applied to a variety of electronic devices (including game machines). Examples of electronic devices are a television set (also referred to as a television or a television receiver), a monitor of a computer or the like, a camera such as a digital camera or a digital video camera, a digital photo frame, a mobile phone handset (also referred to as a mobile phone or a mobile phone device), a portable game machine, a portable information terminal, an audio reproducing device, a large-sized game machine such as a pachinko machine, and the like.

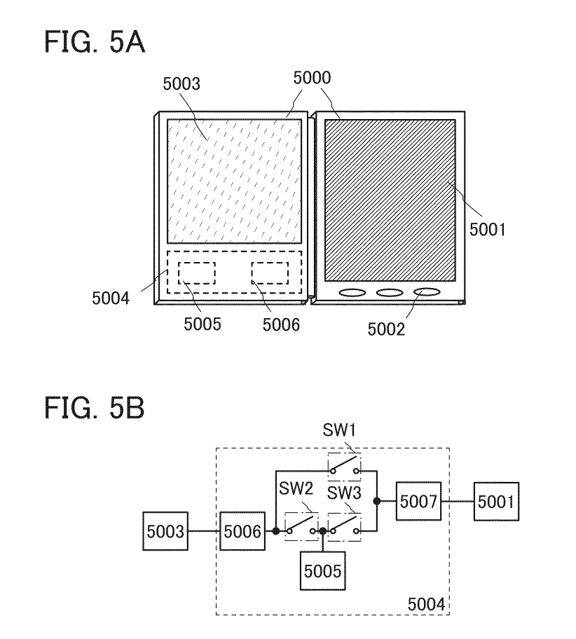

FIG. 5A illustrates an electronic book reader (also referred to as e-book) which can include housings 5000, a display portion 5001, operation keys 5002, a solar cell 5003, and a charge and discharge control circuit 5004. The electronic book reader in FIG. 5A can have a function of displaying a variety of information (e.g., a still image, a moving image, and a text image) on the display portion, a function of displaying a calendar, a date, the time, and the like on the display portion, a function of operating or editing the information displayed on the display portion, a function of controlling processing by various kinds of software (programs), and the like. Note that in FIG. 5A, a structure including a battery 5005 and a DCDC converter (hereinafter abbreviated as a converter) 5006 is illustrated as an example of the charge and discharge control circuit 5004. By application of the liquid crystal display device described in Embodiment 3 or Embodiment 4 to the display portion 5001, an electronic book reader which has high contrast and high visibility and is capable of high-speed response, high performance, and low voltage driving can be provided.

In the case of using a semi-transmissive or reflective liquid crystal display device as the display portion 5001 in the structure illustrated in FIG. 5A, the electronic book reader may be used in a comparatively bright environment. In that case, power generation by the solar cell 5003 and charge by the battery 5005 can be effectively performed, which is preferable. Since the solar cell 5003 can be provided on a space (a surface or a rear surface) of the housing 5000 as appropriate, the battery 5005 can be efficiently charged, which is also preferable. When a lithium ion battery is used as the battery 5005, there is an advantage of downsizing or the like.

The structure and the operation of the charge and discharge control circuit 5004 illustrated in FIG. 5A are described with reference to a block diagram in FIG. 5B. The solar cell 5003, the battery 5005, the converter 5006, a converter 5007, switches SW1 to SW3, and the display portion 5001 are illustrated in FIG. 5B, and the battery 5005, the converter 5006, the converter 5007, and the switches SW1 to SW3 correspond to the charge and discharge control circuit 5004.

Here, an example of operation in the case where power is generated by the solar cell 5003 using external light is described. The voltage of power generated by the solar cell 5003 is raised or lowered by the converter 5006 so that the power has a voltage for charging the battery 5005. When the power from the solar cell 5003 is used for the operation of the display portion 5001, the switch SW1 is turned on and the voltage of the power is raised or lowered by the converter 5007 so as to be a voltage needed for the display portion 5001. In addition, when display on the display portion 5001 is not performed, the switch SW1 is turned off and the switch SW2 is turned on so that the battery 5005 may be charged.

Next, operation in the case where power is not generated by the solar cell 5003 using external light is described. The voltage of power accumulated in the battery 5005 is raised or lowered by the converter 5007 by turning on the switch SW3. Then, power from the battery 5005 is used for the operation of the display portion 5001.

Note that although the solar cell 5003 is described as an example of a means for charge, the battery 5005 may be charged by another means. In addition, a combination of the solar cell 5003 and another means for charge may be used.

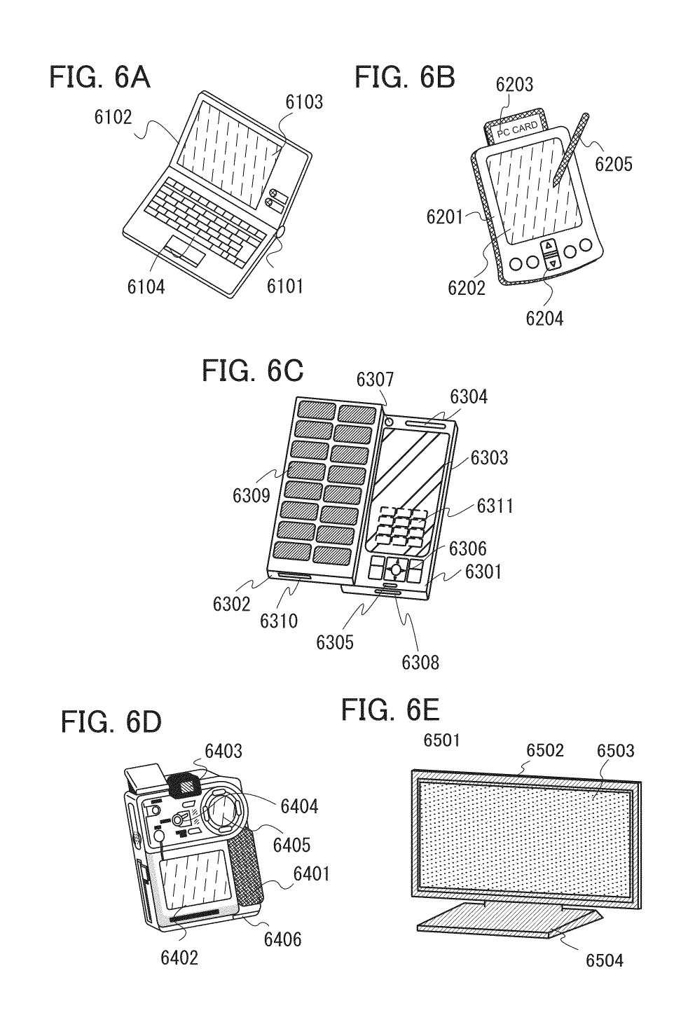

FIG. 6A illustrates a laptop personal computer, which includes a main body 6101, a housing 6102, a display portion 6103, a keyboard 6104, and the like. The liquid crystal display device described in Embodiment 3 or Embodiment 4 is applied to the display portion 6103, whereby a laptop personal computer which has high contrast and high visibility and is capable of high-speed response, high performance, and low voltage driving can be provided.

FIG. 6B illustrates a personal digital assistant (PDA), which includes a main body 6201 provided with a display portion 6202, an external interface 6203, operation buttons 6204, and the like. A stylus 6205 is provided as an accessory for operation. The liquid crystal display device described in Embodiment 3 or Embodiment 4 is applied to the display portion 6202, whereby a personal digital assistant (PDA) which has high contrast and high visibility and is capable of high-speed response, high performance, and low voltage driving can be provided.

FIG. 6C illustrates a mobile phone, which includes two housings, a housing 6301 and a housing 6302. The housing 6301 includes a display panel 6303, a speaker 6304, a microphone 6305, a pointing device 6306, a camera lens 6307, an external connection terminal 6308, and the like. In addition, the housing 6302 includes a solar cell 6309 having a function of charge of the mobile phone, an external memory slot 6310, and the like. An antenna is incorporated in the housing 6301. The liquid crystal display device described in Embodiment 3 or Embodiment 4 is applied to the display panel 6303, whereby a mobile phone which has high contrast and high visibility and is capable of high-speed response, high performance, and low voltage driving can be provided.

Further, the display panel 6303 is provided with a touch panel. A plurality of operation keys 6311 displayed as images is illustrated by dashed lines in FIG. 6C. Note that a boosting circuit by which a voltage output from the solar cell 6309 is increased to be sufficiently high for each circuit is also provided.

The display direction in the display panel 6303 is changed as appropriate depending on a usage pattern. Further, the camera lens 6307 is provided on the same surface as the display panel 6303, so that the mobile phone can be used as a video phone. The speaker 6304 and the microphone 6305 can be used for videophone calls, recording and playing sound, and the like as well as voice calls. Furthermore, the housings 6301 and 6302 which are developed as illustrated in FIG. 6C can overlap with each other by sliding; thus, the size of the mobile phone can be decreased, which makes the mobile phone suitable for being carried.

The external connection terminal 6308 can be connected to an AC adapter and various types of cables such as a USB cable, and charging and data communication with a personal computer are possible. Moreover, a large amount of data can be stored by inserting a storage medium into the external memory slot 6310 and can be moved.

Further, in addition to the above functions, an infrared communication function, a television reception function, or the like may be provided.

FIG. 6D illustrates a digital video camera, which includes a main body 6401, a display portion A 6402, an eyepiece 6403, an operation switch 6404, a display portion B 6405, a battery 6406, and the like. The liquid crystal display device described in Embodiment 3 or Embodiment 4 is applied to the display portion A 6402 and the display portion B 6405, whereby a digital video camera which has high contrast and high visibility and is capable of high-speed response, high performance, and low voltage driving can be provided.

FIG. 6E illustrates an example of a television set. In a television set 6501, a display portion 6503 is incorporated in a housing 6502. The display portion 6503 can display images. Here, the housing 6502 is supported by a stand 6504. When the liquid crystal display device described in Embodiment 3 or Embodiment 4 is applied to the display portion 6503, the television set 6501 which has high contrast and high visibility and is capable of high-speed response, high performance, and low voltage driving can be obtained.

The television set 6501 can be operated by an operation switch of the housing 6502 or a separate remote controller. Further, the remote controller may be provided with a display portion for displaying data output from the remote controller.

Note that the television set 6501 is provided with a receiver, a modem, and the like. With the use of the receiver, general television broadcasting can be received. Moreover, when the television set 6501 is connected to a communication network with or without wires via the modem, one-way (from a sender to a receiver) or two-way (between a sender and a receiver or between receivers) data communication can be performed.

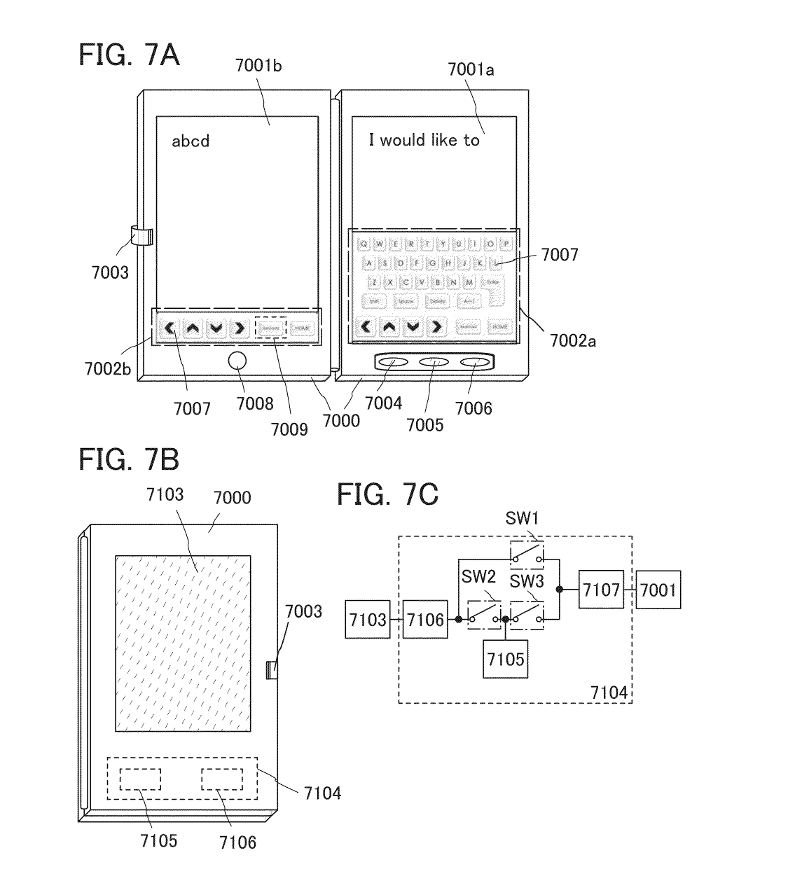

FIGS. 7A and 7B illustrate a tablet terminal that can be folded. In FIG. 7A, the tablet terminal is opened, and includes a housing 7000, a display portion 7001a, a display portion 7001b, a display-mode switching button 7004, a power button 7005, a power-saving-mode switching button 7006, a clip 7003, and an operation button 7008. The tablet terminal is manufactured using a light-emitting device for one of or both the display portion 7001a and the display portion 7001b.

A touch panel area 7002a can be provided in part of the display portion 7001a, in which area, data can be input by touching displayed operation keys 7007. In FIG. 7A, a half of the display portion 7001a has only a display function and the other half has a touch panel function. However, one embodiment of the present invention is not limited to this structure, and the whole display portion 7001a may have a touch panel function. For example, the display portion 7001a can display a keyboard in the whole region to be used as a touch panel, and the display portion 7001b can be used as a display screen.

A touch panel area 7002b can be provided in part of the display portion 7001b like in the display portion 7001a. By touching a keyboard display switching button 7009 displayed on the touch panel with a finger, a stylus, or the like, a keyboard can be displayed on the display portion 7001b.

Touch input can be performed concurrently on the touch panel area 7002a and the touch panel area 7002b.

The display-mode switching button 7004 allows switching between a landscape mode and a portrait mode, color display and black-and-white display, and the like. The power-saving-mode switching button 7006 allows optimizing the display luminance in accordance with the amount of external light in use which is detected by an optical sensor incorporated in the tablet terminal. In addition to the optical sensor, another detecting device such as a sensor for detecting inclination, like a gyroscope or an acceleration sensor, may be incorporated in the tablet terminal.

Although the display portion 7001a and the display portion 7001b have the same display area in FIG. 7A, one embodiment of the present invention is not limited to this example. The display portion 7001a and the display portion 7001b may have different areas or different display quality. For example, higher definition images may be displayed on one of the display portions 7001a and 7001b.

FIG. 7B illustrates the tablet terminal folded, which includes the housing 7000, a solar battery 7103, a charge and discharge control circuit 7104, a battery 7105, and a DCDC converter 7106. Note that FIG. 7B shows an example in which the charge and discharge control circuit 7104 includes the battery 7105 and the DCDC converter 7106.

Since the tablet terminal can be folded, the housing 7000 can be closed when not in use. Thus, the display portions 7001a and 7001b can be protected, which makes it possible to provide a tablet terminal with high durability and improved reliability for long-term use.

The tablet terminal illustrated in FIGS. 7A and 7B can have other functions such as a function of displaying a variety of kinds of data (e.g., a still image, a moving image, and a text image), a function of displaying a calendar, a date, the time, or the like on the display portion, a touch-input function of operating or editing the data displayed on the display portion by touch input, and a function of controlling processing by a variety of kinds of software (programs).

The solar battery 7103, which is attached on the surface of the tablet terminal, supplies electric power to a touch panel, a display portion, an image signal processor, and the like. Note that the solar battery 7103 can be provided on one or both surfaces of the housing 7000, so that the battery 7105 can be charged efficiently. The use of a lithium ion battery as the battery 7105 is advantageous in downsizing or the like.

The structure and operation of the charge and discharge control circuit 7104 illustrated in FIG. 7B are described with reference to a block diagram of FIG. 7C. FIG. 7C illustrates the solar battery 7103, the battery 7105, the DCDC converter 7106, a converter 7107, switches SW1 to SW3, and the display portion 7001. The battery 7105, the DCDC converter 7106, the converter 7107, and the switches SW1 to SW3 correspond to the charge and discharge control circuit 7104 in FIG. 7B.

First, a description is given of an example of the operation in the case where power is generated by the solar battery 7103 using external light. The voltage of power generated by the solar battery is raised or lowered by the DCDC converter 7106 so that a voltage for charging the battery 7105 is obtained. When the power from the solar battery 7103 is used for the operation of the display portion 7001 (7001a, 7001b), the switch SW1 is turned on and the voltage of the power is raised or lowered by the converter 7107 to a voltage needed for operating the display portion 7001. When display is not performed on the display portion 7001, the switch SW1 is turned off and the switch SW2 is turned on so that the battery 7105 can be charged.

Although the solar battery 7103 is shown as an example of a charge means, there is no particular limitation on the charge means and the battery 7105 may be charged with another means such as a piezoelectric element or a thermoelectric conversion element (Peltier element). For example, the battery 7105 may be charged with a non-contact power transmission module that transmits and receives power wirelessly (without contact) to charge the battery or with a combination of other charging means.

It is needless to say that one embodiment of the present invention is not limited to the electronic device illustrated in FIGS. 7A to 7C as long as the display portion described in the above embodiment is included.

This embodiment can be implemented in appropriate combination with any of the structures described in the other embodiments.

### Example 1

In this example, evaluation results and measurement results of five kinds of liquid crystalline monomers represented by the general formula (G1) or the general formula (G1-1) in this specification, and evaluation results and measurement results of five kinds of liquid crystal compositions which are embodiments of the present invention and are manufactured using the respective five kinds of liquid crystalline monomers will be described.

Note that structural formulae of the five kinds of liquid crystalline monomers used in this example are shown below.

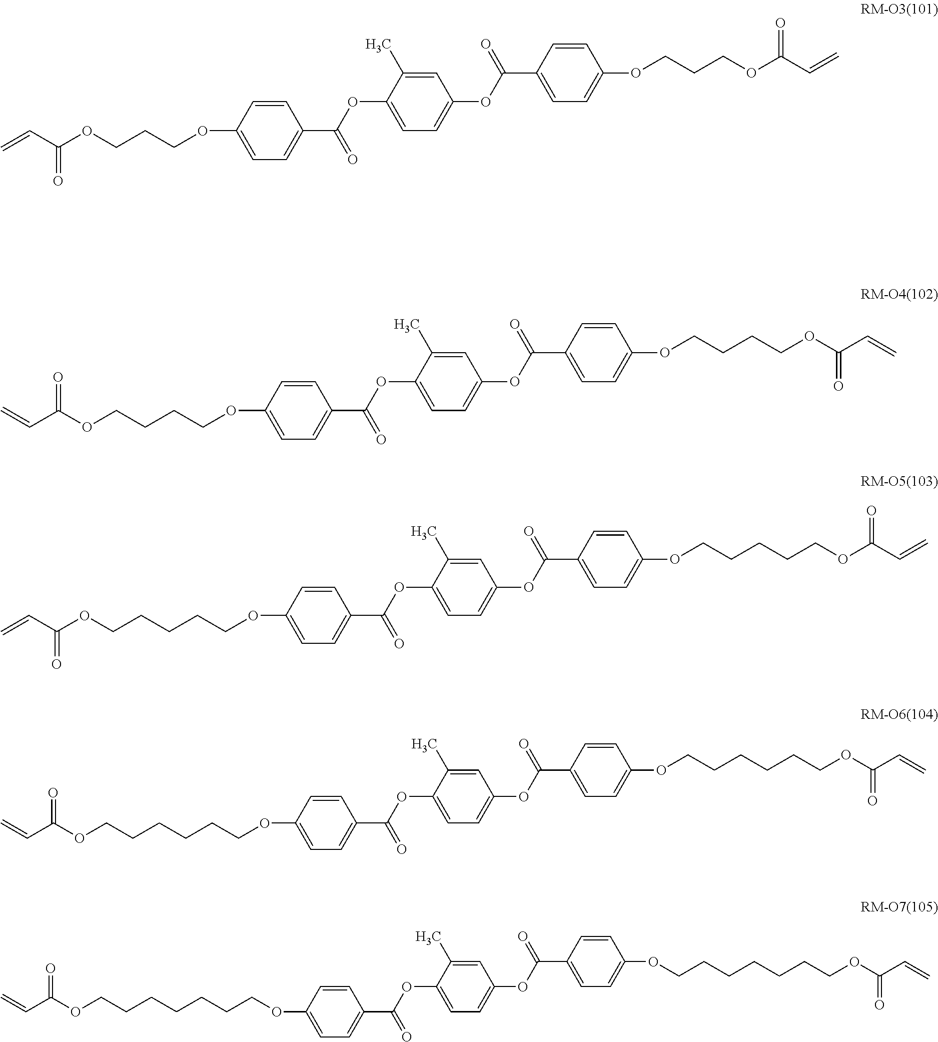

First, the phase transition temperature from a nematic phase to an isotropic phase (T_{NI}) (also referred to as clear point or NI point) of each of the five kinds of liquid crystalline monomers was measured.

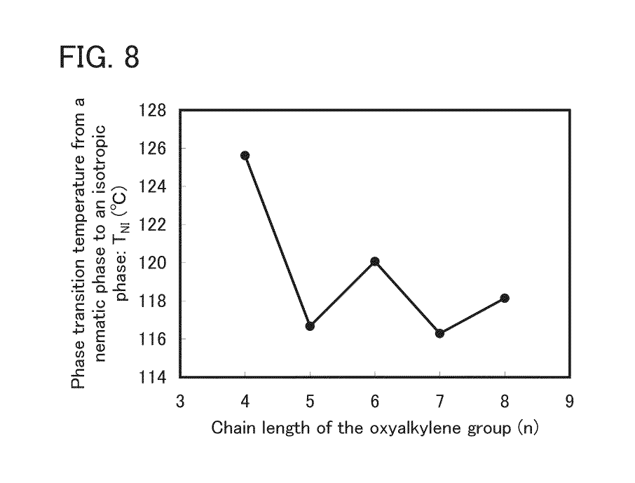

The phase transition temperature from the nematic phase to the isotropic phase (T_{NI}) was measured with a differential scanning calorimeter (DSC) (Pyris 1 DSC, manufactured by Perkin Elmer Co., Ltd.). The measurement was performed under the following conditions: hydroquinone, which is a polymerization inhibitor, was added to each of the five kinds of liquid crystalline monomers to be contained at 0.5 wt %; the temperature was increased from −10° C. at 10° C./min; and the temperature at which an exothermic peak due to the phase transition from the nematic phase to the isotropic phase rises was set as a phase transition temperature from the nematic phase to the isotropic phase (T_{NI}). Note that the measurement results of the phase transition temperature from the nematic phase to the isotropic phase (T_{NI}) are shown in FIG. 8.

As shown in the measurement results of FIG. 8, the liquid crystalline monomers show characteristics in which the phase transition temperature is alternately increased and decreased every time the chain length (the sum of carbon atoms and oxygen atoms) of an oxyalkylene group in the general formula (G1) or the general formula (G1-1) is increased by one value, i.e., a parity with respect to the chain length (the sum of carbon atoms and oxygen atoms) of the oxyalkylene group.

Next, the five kinds of liquid crystal compositions including the respective five kinds of liquid crystalline monomers were formed, and states thereof at the time of polymer stabilization are described below.

In the formation of the five kinds of liquid crystal compositions in this example, E-8 (abbreviation) (manufactured by LCC Corporation), 4-(trans-4-propylcyclohexyl)-3′,4′-difluoro-1,1′-biphenyl (abbreviation: CPP-3FF), and 4-pentylbenzoic acid 4-cyano-3-fluorophenyl ester (abbreviation: PEP-5CNF) were used as a liquid crystal material exhibiting a blue phase; dodecyl methacrylate (abbreviation: DMeAc) (manufactured by Tokyo Chemical Industry Co., Ltd.) was used as a non-liquid-crystalline monomer; DMPAP (abbreviation) (manufactured by Tokyo Chemical Industry Co., Ltd.) was used as a polymerization initiator; and 1,4:3,6-dianhydro-2,5-bis[4-(n-hexyl-1-oxy)benzoic acid]sorbitol (abbreviation: ISO-(6OBA)₂) (manufactured by Midori Kagaku Co., Ltd.) was used as a chiral material. As the liquid crystalline monomer, the five kinds of materials represented by the above structural formulae were used for the respective five kinds of liquid crystal compositions. Note that structural formulae of the above substances other than the liquid crystalline monomers are shown below.

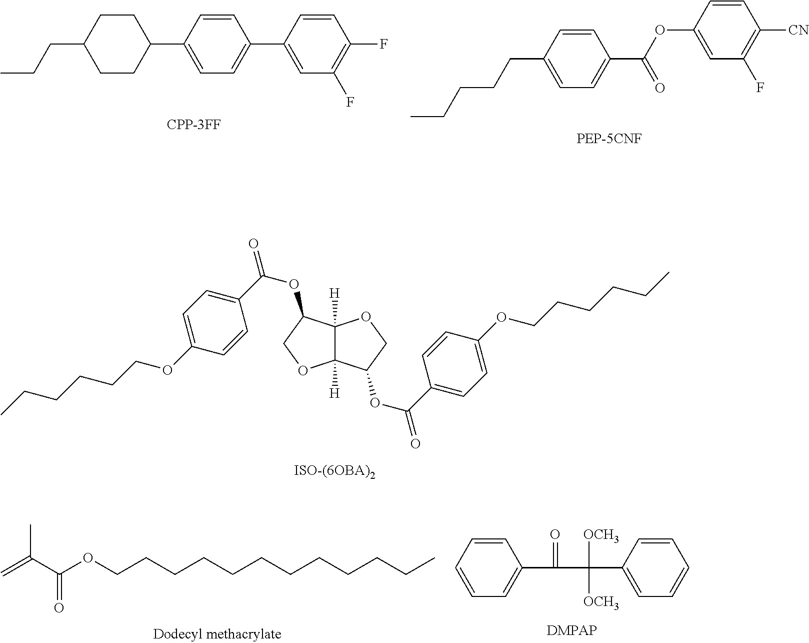

In this example, the five kinds of liquid crystal compositions were formed with the mixture ratios shown in Table 1, and were subjected to polymer stabilization treatment. The mixture ratios are all represented in weight ratios (wt %).

TABLE 1

| | | Mixture Ratios |
|---|---|---|
| Classification | Materials | (wt %) |
| Liquid Crystal Material | E-8 | 34.0 |
| | CPP-3FF | 25.5 |
| | PEP-5CNF | 25.5 |
| Non-liquid-crystalline Monomer | dodecyl methacrylate | 4.0 |
| Liquid Crystalline Monomer | RM-O3 | 4.0 |
| (Any One Kind) | RM-O4 | |
| | RM-O5 | |
| | RM-O6 | |
| | RM-O7 | |
| Polymerization Initiator | DMPAP | Small Amount |
| Chiral Material | ISO-(6OBA)₂ | 6.9 |
| Total | | 100.0 |

In this example, liquid crystal cells including the respective liquid crystal compositions shown in Table 1 were manufactured, and were subjected to polymer stabilization treatment. Note that the liquid crystal cells were each formed in the following manner: an ultraviolet light and heat curable sealant was applied to a pair of glass substrates with a space (4 μm) therebetween; the substrates were irradiated with ultraviolet light (having an irradiance of 100 mW/cm²) for 90 seconds; the substrates were heated at 120° C. for one hour to be bonded to each other; and the liquid crystal composition mixed with the ratios shown in Table 1 was injected between the substrates.

The liquid crystalline monomers used for the respective liquid crystal cells (Liquid Crystal Cells 1 to 5) are shown in Table 2.

TABLE 2

| | Liquid Crystalline | Chain Length of Oxyalkylene |
|---|---|---|
| | Monomer | Group (C + O) |
| Liquid Crystal Cell 1 | RM-O3 | 4 |
| Liquid Crystal Cell 2 | RM-O4 | 5 |
| Liquid Crystal Cell 3 | RM-O5 | 6 |
| Liquid Crystal Cell 4 | RM-O6 | 7 |
| Liquid Crystal Cell 5 | RM-O7 | 8 |

Next, the liquid crystal compositions in the respective liquid crystal cells were subjected to polymer stabilization treatment. In this example, polymer stabilization treatment was performed in the following manner: the liquid crystal cells were heated to a temperature at which the liquid crystal compositions in the respective liquid crystal cells exhibit an isotropic phase, and were irradiated with ultraviolet light (having a wavelength of 365 nm and an irradiance of 8 mW/cm²) for 6 minutes with the isotropic phase exhibited and for 6 minutes with a blue phase exhibited. Note that Table 3 shows the phase transition temperature from the isotropic phase to the blue phase, the process temperature at the time of polymer stabilization treatment with the isotropic phase exhibited (shown as “Stabilization Treatment Temperature from Isotropic Phase” in Table 3), and the process temperature at the time of polymer stabilization treatment with the blue phase exhibited (shown as “Stabilization Treatment Temperature from Blue Phase” in Table 3) of the liquid crystal composition in each of the liquid crystal cells.

TABLE 3

| | | Stabilization | Stabilization |
|---|---|---|---|
| | Phase Transition | Treatment | Treatment |
| | Temperature from | Temperature | Temperature |
| | Isotropic Phase to | from | from |
| | Blue Phase | Isotropic Phase | Blue Phase |
| | (° C.) | (° C.) | (° C.) |
| Liquid Crystal Cell 1 | 38.4 | 39.0 | 36.0 |
| Liquid Crystal Cell 2 | 35.9 | 38.0 | 35.0 |
| Liquid Crystal Cell 3 | 39.4 | 41.0 | 38.0 |
| Liquid Crystal Cell 4 | 36.4 | 40.0 | 34.0 |
| Liquid Crystal Cell 5 | 39.8 | 43.0 | 34.0 |

Then, a texture (also referred to as optical texture or pattern observed with a microscope) of each of the liquid crystal cells after the polymer stabilization treatment was observed. For the observation of the texture, a polarizing microscope (MX-50 manufactured by Olympus Corporation) was used.

The measurement was performed with the polarizing microscope under the following conditions: a measurement mode was a transmissive mode; polarizers were disposed in crossed nicols; the magnification was 500 times; and the temperature was room temperature.

Textures of the liquid crystal cells (Liquid Crystal Cells 1 to 5) which were each subjected to polymer stabilization treatment and exhibited a polymer-stabilized blue phase are shown in FIGS. 9A-1, 9A-2, 9B-1, 9B-2, 9C-1, 9C-2, 9D-1, 9D-2, 9E-1, and 9E-2. Further, the liquid crystal cells (Liquid Crystal Cells 1 to 5), the chain lengths (the sums of oxygen atoms and carbon atoms) of oxyalkylene groups of the liquid crystalline monomers in the respective liquid crystal cells, and the textures in FIGS. 9A-1, 9A-2, 9B-1, 9B-2, 9C-1, 9C-2, 9D-1, 9D-2, 9E-1, and 9E-2 are shown in Table 4.

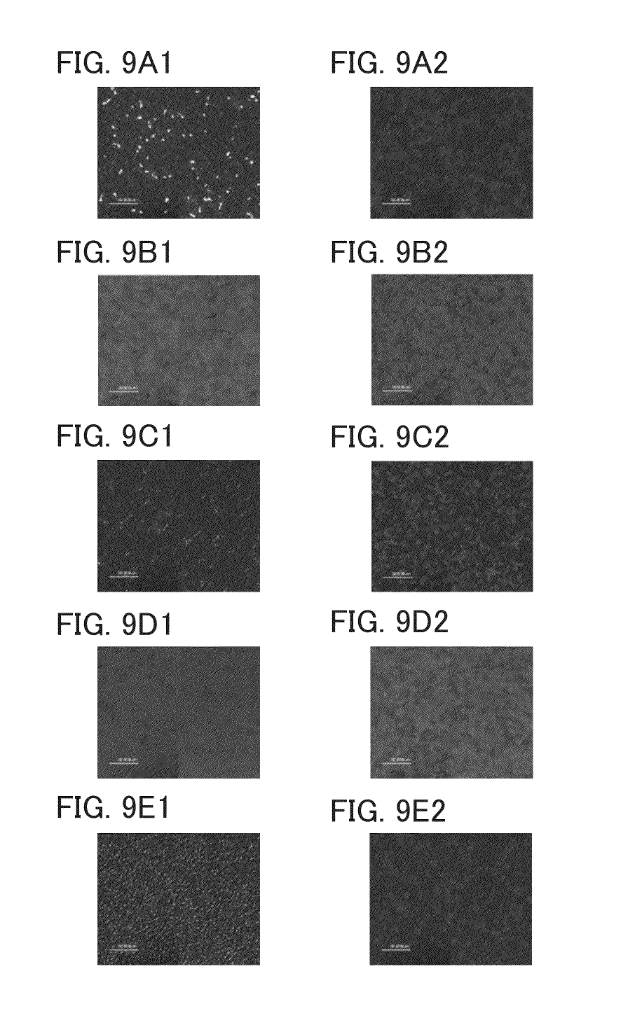

TABLE 4

| | | Alignment | Alignment |
|---|---|---|---|
| | | State after | State after |
| | Chain Length | Stabilization | Stabilization |
| | of | Treatment with | Treatment with |
| | Oxyalkylene | Isotropic Phase | Blue Phase |
| | Group (C + O) | Exhibited | Exhibited |
| Liquid Crystal Cell 1 | 4 | FIG. 9A-1 | FIG. 9A-2 |
| Liquid Crystal Cell 2 | 5 | FIG. 9B-1 | FIG. 9B-2 |
| Liquid Crystal Cell 3 | 6 | FIG. 9C-1 | FIG. 9C-2 |
| Liquid Crystal Cell 4 | 7 | FIG. 9D-1 | FIG. 9D-2 |
| Liquid Crystal Cell 5 | 8 | FIG. 9E-1 | FIG. 9E-2 |

FIGS. 9A-1, 9A-2, 9B-1, 9B-2, 9C-1, 9C-2, 9D-1, 9D-2, 9E-1, and 9E-2 show the following: in the case where the chain length of an oxyalkylene group is an even number (specifically, 4, 6, or 8) and polymer stabilization treatment is performed with an isotropic phase exhibited, a large number of defects exist as shown in FIGS. 9A-1, 9C-1, and 9E-1 when a blue phase is exhibited. Further, in the case where the chain length of an oxyalkylene group is an even number (specifically, 4, 6, or 8) and polymer stabilization treatment is performed with a blue phase exhibited, a platelet texture (small-plate-like texture) having boundaries is observed as shown in FIGS. 9A-2, 9C-2, and 9E-2 when the blue phase is exhibited.

Further, in the case where the chain length of an oxyalkylene group is an odd number (specifically, 5 or 7), the texture which does not show a clear platelet state is observed both when polymer stabilization treatment is performed with an isotropic phase exhibited (FIGS. 9B-1 and 9D-1) and when polymer stabilization treatment is performed with a blue phase exhibited (FIGS. 9B-2 and 9D-2).

Accordingly, with the use of a liquid crystal composition including a liquid crystalline monomer which includes an oxyalkylene group whose chain length is an even number (specifically, 4, 6, or 8), a polymer-stabilized blue phase in which generation of an alignment defect is reduced can be obtained by performing polymer stabilization treatment with a blue phase exhibited; on the other hand, with the use of a liquid crystal composition including a liquid crystalline monomer which includes an oxyalkylene group whose chain length is an odd number (specifically, 5 or 7), a polymer-stabilized blue phase in which generation of an alignment defect is reduced can be obtained by polymer stabilization treatment with an isotropic phase or a blue phase exhibited.

### Example 2

In this example, a liquid crystal panel was manufactured through polymer stabilization treatment with an isotropic phase exhibited using the liquid crystal composition which was used for Liquid Crystal Cell 4 in Example 1 and includes the liquid crystalline monomer (RM-O6) including the oxyalkylene group whose chain length is an odd number (specifically, 7), a liquid crystal panel was manufactured through polymer stabilization treatment with a blue phase exhibited using the above liquid crystal composition, and a liquid crystal panel was manufactured through polymer stabilization treatment with a blue phase exhibited using the liquid crystal composition which was used for Liquid Crystal Cell 1 in Example 1 and includes the liquid crystalline monomer (RM-O3) including the oxyalkylene group whose chain length is an even number (specifically, 4).

First, a method of manufacturing the liquid crystal panel through polymer stabilization treatment with the isotropic phase exhibited using the liquid crystal composition which includes the liquid crystalline monomer (RM-O6) including the oxyalkylene group whose chain length (the sum of carbon atoms and oxygen atoms) is 7 will be described.

A gap spacer made of a resin with a height of 4 μm and a photocurable and thermosetting sealant (SD-25, manufactured by SEKISUI CHEMICAL CO., LTD.) were formed on a 5-inch glass substrate used as a first substrate. Further, over a 5-inch glass substrate used as a second substrate, a circuit including, for example, a transistor having an electrode layer for driving a liquid crystal layer was formed.

Next, the first substrate on which the sealant was formed was irradiated with ultraviolet light (having an irradiance of 11 mW/cm²), so that the sealant was temporarily cured.

Then, the liquid crystal composition (including the liquid crystalline monomer (RM-O6) including the oxyalkylene group whose chain length (the sum of carbon atoms and oxygen atoms) is 7) which was used for Liquid Crystal Cell 4 in Example 1 was dropped on the inner side than the sealant on the first substrate. At this time, the temperature of the liquid crystal composition was set to 70° C. at which an isotropic phase is exhibited, and about 14 mg of the liquid crystal composition was dropped on the inner side than the sealant.

Next, the first substrate and the second substrate were bonded to each other. Here, the second substrate whose one surface provided with the circuit including, for example, the transistor having the electrode layer faces downward was fixed to the upper side of a chamber with an electrostatic chuck, and the first substrate whose one surface provided with the liquid crystal composition faces upward was placed on the lower side of the chamber. After that, the pressure in the chamber was reduced to 100 Pa, and the first substrate and the second substrate were bonded to each other. Then, the chamber was exposed to the atmosphere.

Next, a substrate in which the first substrate and the second substrate are bonded to each other was disposed on a stage provided with a heat source, and the liquid crystal layer including the liquid crystal composition (including the liquid crystalline monomer (RM-O6) including the oxyalkylene group whose chain length (the sum of carbon atoms and oxygen atoms) is 7) was heated to 70° C.; thus, the isotropic phase was exhibited.

Next, the liquid crystal layer exhibiting the isotropic phase was rapidly cooled to 38° C. at −5° C./min. Then, the temperature was kept at 38° C. at which the whole liquid crystal layer exhibits the isotropic phase, and the liquid crystal layer was irradiated with ultraviolet light (11 mW/cm²) having a main wavelength of 365 nm for 6 minutes using a sharp cut filter cutting light having a wavelength of 350 nm or shorter. In this manner, polymer stabilization treatment was performed. As a result, the phase transition of the liquid crystal layer from the isotropic phase to a blue phase occurred, and thus the liquid crystal layer exhibiting a polymer-stabilized blue phase was obtained.

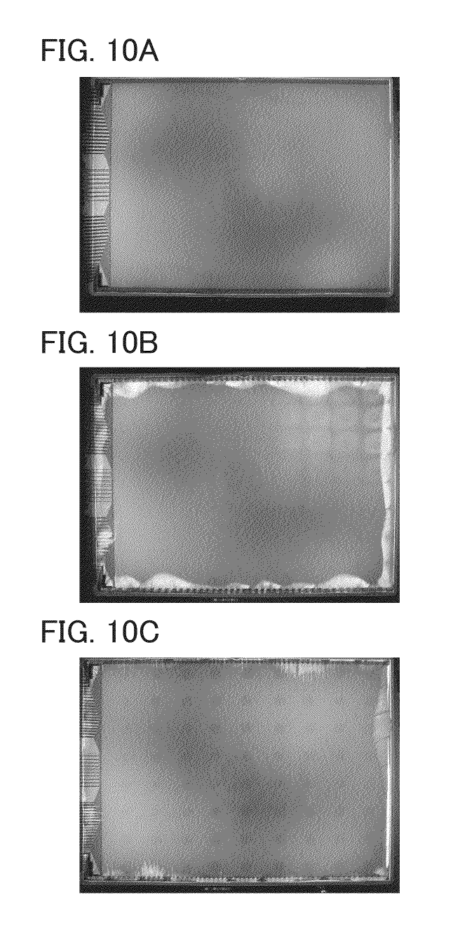

The substrate was subjected to heat treatment (at 120° C. for one hour) with this state, whereby the sealant was fully cured. In this manner, the liquid crystal panel was obtained through the polymer stabilization treatment with the isotropic phase exhibited using the liquid crystal composition including the liquid crystalline monomer (RM-O6) which includes the oxyalkylene group whose chain length (the sum of carbon atoms and oxygen atoms) is 7. FIG. 10A is a photograph showing the appearance of the thus obtained liquid crystal panel.

In a manner similar to the above, a substrate in which a liquid crystal layer including the liquid crystal composition (including the liquid crystalline monomer (RM-O6) including the oxyalkylene group whose chain length (the sum of carbon atoms and oxygen atoms) is 7) which was used for Liquid Crystal Cell 4 in Example 1 is provided in a space surrounded by a first substrate, a second substrate, and a sealant (temporarily cured) was disposed on a stage provided with a heat source. Then, the liquid crystal layer was heated to 70° C. to exhibit an isotropic phase. After that, the temperature was decreased from 70° C. at −1° C./min so that the phase transition of the liquid crystal layer from the isotropic phase to a blue phase occurred. Next, the temperature was kept at a temperature at which the whole liquid crystal layer exhibits the blue phase (here, 34° C.), and the liquid crystal layer was irradiated with ultraviolet light (8 mW/cm²) having a main wavelength of 365 nm for 6 minutes using a sharp cut filter cutting light having a wavelength of 350 nm or shorter. In this manner, polymer stabilization treatment was performed.

Next, the substrate was subjected to heat treatment (at 120° C. for one hour), whereby the sealant was fully cured. In this manner, the liquid crystal panel was obtained through the polymer stabilization treatment with the blue phase exhibited using the liquid crystal composition including the liquid crystalline monomer (RM-O6) including the oxyalkylene group whose chain length (the sum of carbon atoms and oxygen atoms) is 7. FIG. 10B is a photograph showing the appearance of the thus obtained liquid crystal panel.

Further, a substrate in which a liquid crystal layer including the liquid crystal composition (including the liquid crystalline monomer (RM-O3) including the oxyalkylene group whose chain length (the sum of carbon atoms and oxygen atoms) is 4) which was used for Liquid Crystal Cell 1 in Example 1 is provided in a space surrounded by a first substrate, a second substrate, and a sealant (temporarily cured) was also subjected to polymer stabilization treatment with a blue phase exhibited. FIG. 10C is a photograph showing the appearance of the thus obtained liquid crystal panel.

From the above results, in the liquid crystal panel in FIG. 10C obtained through the polymer stabilization treatment with the blue phase exhibited using the liquid crystal composition including the liquid crystalline monomer (RM-O3) which includes the oxyalkylene group whose chain length (the sum of carbon atoms and oxygen atoms) is 4 (i.e., even number), light leakage due to the phase transition to a cholesteric phase is caused in the whole display region.

However, in the liquid crystal panel in FIG. 10A obtained through the polymer stabilization treatment with the isotropic phase exhibited using the liquid crystal composition including the liquid crystalline monomer (RM-O6) that includes the oxyalkylene group whose chain length (the sum of carbon atoms and oxygen atoms) is 7 (i.e., odd number), an alignment defect is scarcely seen in the display region of the liquid crystal panel; it is shown that generation of an alignment defect can be prevented. In the liquid crystal panel in FIG. 10B obtained through the polymer stabilization treatment with the blue phase exhibited using the liquid crystal composition including the liquid crystalline monomer (RM-O6) that includes the oxyalkylene group whose chain length (the sum of carbon atoms and oxygen atoms) is 7 (i.e., odd number), the liquid crystal layer in the periphery of the liquid crystal panel tends to shrink; however, an alignment defect in the display region of the liquid crystal panel tends to be reduced.

From the above, generation of an alignment defect at the time of polymer stabilization treatment can be prevented with the use of, as a liquid crystalline monomer, a liquid crystal composition including a liquid crystalline monomer which includes an oxyalkylene group whose chain length (the sum of carbon atoms and oxygen atoms) represented as Y in the general formula (G1) is n (n is greater than or equal to 2 and less than or equal to 11) and which has a lower phase transition temperature from a nematic phase to an isotropic phase (T_{NI}) than liquid crystalline monomers which include the oxyalkylene groups whose chain lengths (the sum of carbon atoms and oxygen atoms) are (n−1) and (n+1), that is, whose chain lengths are odd numbers here.

### Reference Example

In this reference example, a synthesis method of 1,4-bis[4-(7-acryloyloxyheptyl-1-oxy)benzoyloxy]-2-methylbenzene (abbreviation: RM-O7), which is a liquid crystalline monomer included in the liquid crystal composition that is one embodiment of the present invention, and represented by the structural formula (105) in Embodiment 1, will be described in detail.

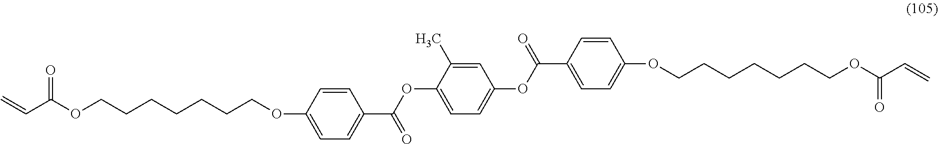 [SMILES: C=CC(=O)OCCCCCCCOc1ccc(C(=O)Oc2ccc(OC(=O)c3ccc(OCCCCCCCOC(=O)C=C)cc3)c(C)c2)cc1]

### Step 1: Synthesis of 4-(7-hydroxyheptyl-1-oxy)benzoic acid ethyl ester

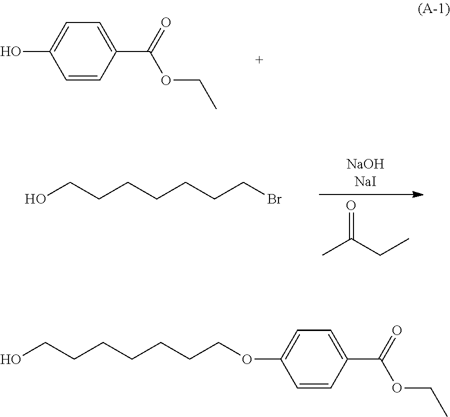

In a 200 mL recovery flask were put 3.5 g (21 mmol) of 4-hydroxybenzoic acid ethyl ester, 4.9 g (25 mmol) of 7-bromo-1-heptanol, 1.0 g (25 mmol) of sodium hydroxide, 3.2 g (21 mmol) of sodium iodide, and 120 mL of 2-butanone, and the mixture was stirred at 60° C. for 11 hours under a nitrogen stream. Then, completion of the reaction was confirmed using TLC and after that, the obtained mixture was gravity filtered and the residue was dissolved in water. The thus obtained solution was extracted three times, and the extracted solution and the filtrate were mixed and dried with magnesium sulfate. The mixture was gravity filtered, and the obtained filtrate was concentrated to give a white solid.

The obtained solid was purified by silica gel column chromatography (a developing solvent of 1000 mL, ethyl acetate:hexane=1:2). The obtained fractions including a target substance were concentrated, so that 5.0 g of a colorless oily substance was obtained in a yield of 85%.

### Step 2: Synthesis of 4-(7-hydroxyheptyl-1-oxy)benzoic acid

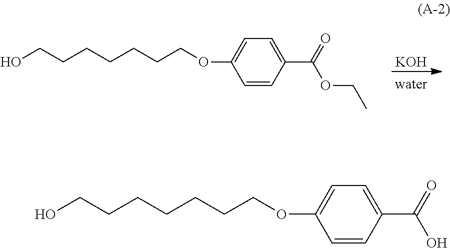 [SMILES: CCOC(=O)c1ccc(OCCCCCCCO)cc1 ; "KOH" ; O=C(O)c1ccc(OCCCCCCCO)cc1]

In a 500 mL recovery flask were put 5.0 g (18 mmol) of 4-(7-hydroxyheptyl-1-oxy)benzoic acid ethyl ester and 150 mL of a potassium hydroxide aqueous solution (0.5 mol/L), and the mixture was stirred at 100° C. for 10 hours under a nitrogen stream. Then, completion of the reaction was confirmed using TLC. Into the obtained solution, diethyl ether and dilute hydrochloric acid were added, and an aqueous layer was subjected to extraction three times with diethyl ether. An organic layer and the extracted solution were mixed and dried with magnesium sulfate. The mixture was separated by gravity filtration, and the filtrate was concentrated to give 3.3 g of a pale yellow solid that was a target substance in a crude yield of 73%.

### Step 3: Synthesis of 4-(7-acryloyloxyheptyl-1-oxy)benzoic acid

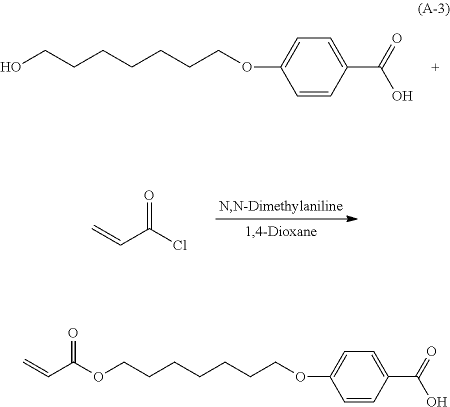

In a 500 mL recovery flask were put 3.3 g (13 mmol) of 4-(7-hydroxyheptyl-1-oxy)benzoic acid, 100 mL of 1,4-dioxane, and 1.9 g (16 mmol) of N,N-dimethylaniline, and the mixture was stirred. Into the solution, 1.4 g (15 mmol) of acryloyl chloride was slowly added, and then the solution was stirred at 60° C. for four hours under a nitrogen stream. Then, completion of the reaction was confirmed using TLC. The obtained solution was slowly added into about 800 mL of water, so that a white solid was precipitated. The white solid was collected by suction filtration and dried to give 3.5 g of a white solid that was a target substance in a crude yield of 88%.

### Step 4: Synthesis of 1,4-bis[4-(7-acryloyloxyheptyl-1-oxy)benzoyloxy]-2-methylbenzene (abbreviation: RM-O7)

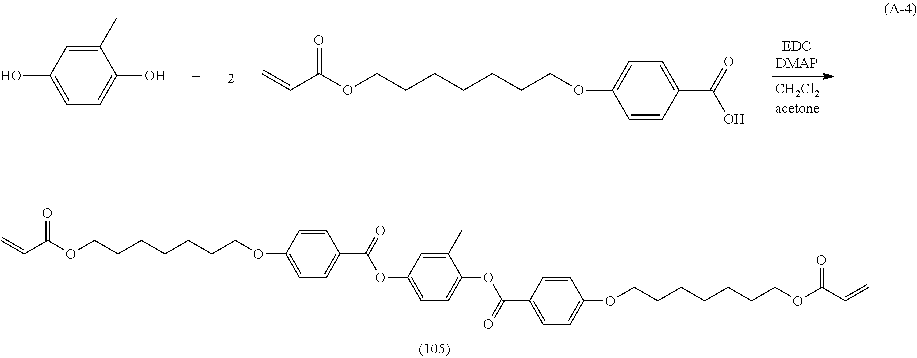

In a 300 mL recovery flask were put 3.5 g (11 mmol) of 4-(7-acryloyloxyheptyl-1-oxy)benzoic acid, 0.71 g (5.7 mmol) of methylhydroquinone, 0.21 g (1.7 mmol) of 4-(N,N-dimethyl)aminopyridine (DMAP), 80 mL of acetone, and 40 mL of dichloromethane, and the mixture was stirred under the air. Into this mixture, 2.2 g (11 mmol) of 1-ethyl-3-(3-dimethylaminopropyl)carbodiimide hydrochloride (EDC) was added, so that all the materials were dissolved to give a solution. This solution was stirred at room temperature for 20 hours under the air.

After completion of the reaction was confirmed using TLC, about 40 mL of chloroform was added to the solution. This solution was concentrated to about 60 mL, and a saturated aqueous solution of sodium hydrogen carbonate and saturated saline were added to the obtained solution. An aqueous layer of this mixture was extracted with chloroform three times, and the extracted solution was combined with an organic layer and then dried with magnesium sulfate. This mixture was separated by gravity filtration, and the filtrate was concentrated to give an oily substance.

The obtained oily substance was purified by silica gel column chromatography (a developing solvent of 700 mL, ethyl acetate:hexane=1:1). The obtained fractions including a target substance were concentrated, so that a colorless oily substance was obtained. The obtained colorless oily substance was purified by high performance liquid chromatography (abbreviated to HPLC, developing solvent: chloroform), so that 0.38 g of a white solid that is a target substance was obtained in a yield of 14%.

It was confirmed that this compound was 1,4-bis[4-(7-acryloyloxyheptyl-1-oxy)benzoyloxy]-2-methylbenzene (abbreviation: RM-O7) by nuclear magnetic resonance (NMR).

¹H NMR data of the obtained compound is shown below. ¹H NMR (CDCl₃, 300 MHz): δ(ppm)=1.38-1.51 (m, 12H), 1.68-1.86 (m, 8H), 2.24 (s, 3H), 4.05 (t, J=5.4 Hz, 4H), 4.17 (t, J=6.6 Hz, 4H), 5.82 (dd, J1=10 Hz, J2=1.5 Hz, 2H), 6.13 (dd, J1=10 Hz, J2=17 Hz, 2H), 6.41 (dd, J1=1.5 Hz, J2=17 Hz, 2H), 6.95-7.00 (m, 4H), 7.06-7.19 (m, 3H), 8.12-8.18 (m, 4H).

Note that synthesis of 1,4-bis[4-(5-acryloyloxypentyl-1-oxy)benzoyloxy]-2-methylbenzene (abbreviation: RM-O5) was performed in such a manner that, in the step represented by the reaction formula (A-1) in the synthesis of RM-O7 (abbreviation) described in this reference example, 5-bromo-1-pentanol was used instead of 7-bromo-1-heptanol and reactions corresponding to the reaction formulae (A-2) to (A-4) were made to occur.

Further, the syntheses of 1,4-bis[4-(2-methacryloyloxyethyl-1-oxy)benzoyloxy]-2-methylbenzene (abbreviation: MeRM-02) and 1,4-bis[4-(4-acryloyloxybutyl-1-oxy)benzoyloxy]-2-methylbenzene (abbreviation: RM-O4) described in Embodiment 1 were performed using 4-(2-methacryloyloxy-1-oxy)benzoic acid and 4-(4-acryloyloxybutyl-1-oxy)benzoic acid, respectively, instead of 4-(7-acryloyloxyheptyl-1-oxy)benzoic acid in the step represented by the reaction formula (A-4) in the synthesis of RM-O7 (abbreviation) described in this reference example.

This application is based on Japanese Patent Application serial no. 2011-238282 filed with Japan Patent Office on Oct. 31, 2011, the entire contents of which are hereby incorporated by reference.

What is claimed is:

1. A liquid crystal composition comprising a liquid crystal material exhibiting a blue phase and a liquid crystalline monomer represented by a general formula (G1), 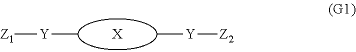
wherein in the general formula (G1):
X represents a mesogenic skeleton;
Y represents an oxyalkylene group (including carbon and oxygen) and includes hydrogen or fluorine; and
Z₁ and Z₂ individually represent an acryloyl group or a methacryloyl group,
wherein a sum of carbon atoms and oxygen atoms of the oxyalkylene group is n, n being 2 or more and 11 or less, and
wherein the liquid crystalline monomer has a lower phase transition temperature from a nematic phase to an isotropic phase than a liquid crystalline monomer including the oxyalkylene group in which a sum of carbon atoms and oxygen atoms is (n−1) and a liquid crystalline monomer including the oxyalkylene group in which a sum of carbon atoms and oxygen atoms is (n+1).

2. The liquid crystal composition according to claim 1,
wherein X in the general formula (G1) is represented by any one of the following structural formulae (s11) to (s18), 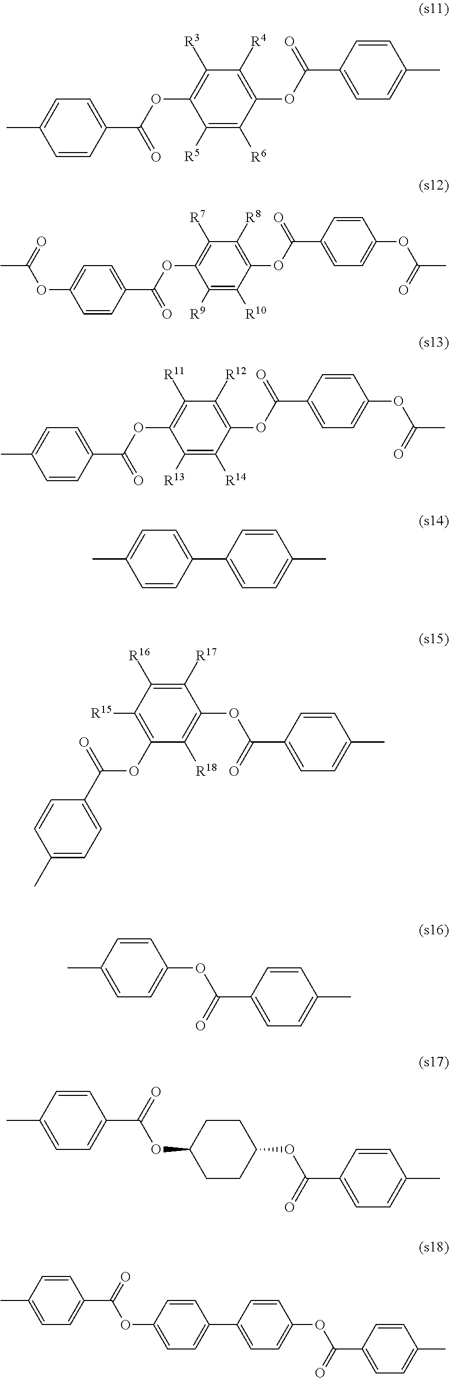
wherein R³ to R⁶ in the structural formula (s11), R⁷ to R¹⁰ in the structural formula (s12), R¹¹ to R¹⁴ in the structural formula (s13), and R¹⁵ to R¹⁸ in the structural formula (s15) individually represent any one of hydrogen, a methyl group, and fluorine.

3. The liquid crystal composition according to claim 1,
wherein the liquid crystalline monomer represented by the general formula (G1) has a structure represented by the following structural formula (104),

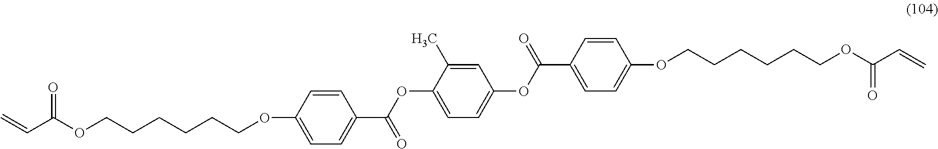

4. The liquid crystal composition according to claim 1,
wherein the liquid crystalline monomer represented by the general formula (G1) has a structure represented by the following structural formula (102),

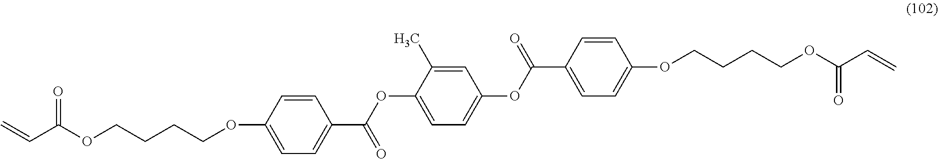

5. The liquid crystal composition according to claim 1, further comprising a non-liquid-crystalline monomer and a polymerization initiator.

6. A polymer/liquid crystal composite comprising the liquid crystal composition according to claim 1.

7. A liquid crystal element comprising the liquid crystal composition according to claim 1.

8. A liquid crystal element comprising the polymer/liquid crystal composite according to claim 6.

9. A liquid crystal display device comprising the liquid crystal element according to claim 7.

10. A liquid crystal display device comprising the liquid crystal element according to claim 8.

11. A liquid crystal composition comprising a liquid crystal material exhibiting a blue phase and a liquid crystalline monomer represented by a general formula (G1-1), 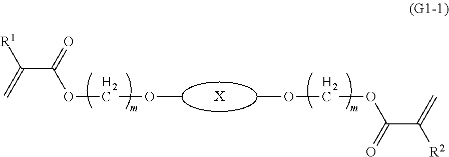
wherein in the general formula (G1-1):
X represents a mesogenic skeleton; and
R¹ and R² individually represent hydrogen or a methyl group,
wherein a sum of carbon atoms and oxygen atoms of an oxyalkylene group in the general formula (G1-1) is n,
wherein n=m+1, n being 2 or more and 11 or less, and
wherein the liquid crystalline monomer has a lower phase transition temperature from a nematic phase to an isotropic phase than a liquid crystalline monomer including the oxyalkylene group in which a sum of carbon atoms and oxygen atoms is (n−1) and a liquid crystalline monomer including the oxyalkylene group in which a sum of carbon atoms and oxygen atoms is (n+1).

12. The liquid crystal composition according to claim 11,
wherein X in the general formula (G1-1) is represented by any one of the following structural formulae (s11) to (s18), 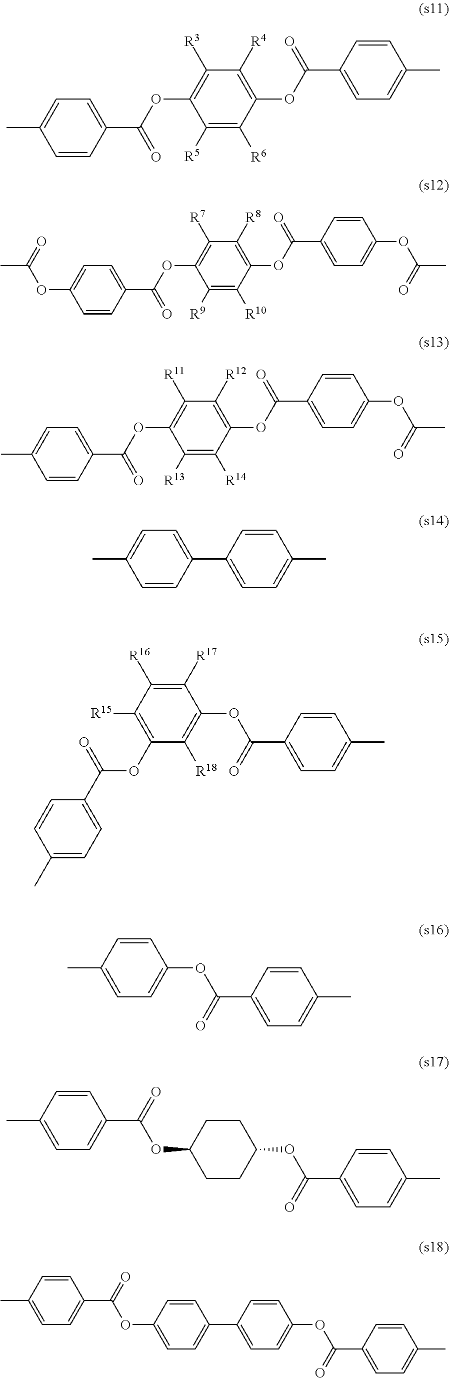
wherein R³ to R⁶ in the structural formula (s11), R⁷ to R¹⁰ in the structural formula (s12), R¹¹ to R¹⁴ in the structural formula (s13), and R¹⁵ to R¹⁸ in the structural formula (s15) individually represent any one of hydrogen, a methyl group, and fluorine.

13. The liquid crystal composition according to claim 11,
wherein the liquid crystalline monomer represented by the general formula (G1-1) has a structure represented by the following structural formula (104),

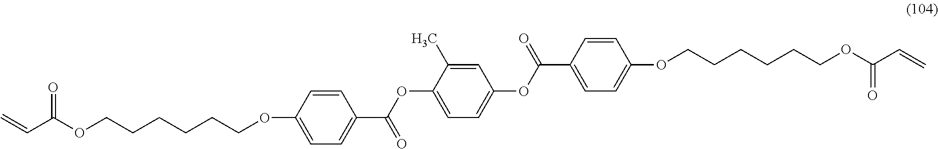

14. The liquid crystal composition according to claim 11,
wherein the liquid crystalline monomer represented by the general formula (G1-1) has a structure represented by the following structural formula (102),

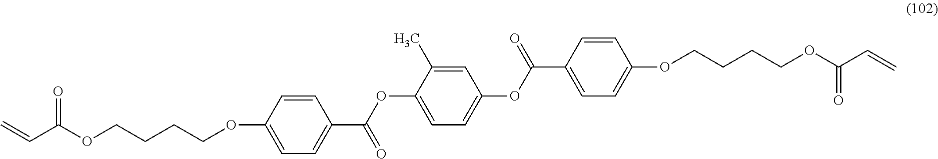

15. The liquid crystal composition according to claim 11, further comprising a non-liquid-crystalline monomer and a polymerization initiator.

16. A polymer/liquid crystal composite comprising the liquid crystal composition according to claim 11.

17. A liquid crystal element comprising the liquid crystal composition according to claim 11.

18. A liquid crystal element comprising the polymer/liquid crystal composite according to claim 16.

19. A liquid crystal display device comprising the liquid crystal element according to claim 17.

20. A liquid crystal display device comprising the liquid crystal element according to claim 18.
